(19) United States
(12) Patent Application Publication
(10) Pub. No.: US 2026/0154029 A1
(43) Pub. Date: Jun. 4, 2026

(54) METHOD OF PROCESSING INFORMATION IN INFORMATION PROCESSING APPARATUS

(71) Applicant: SEIKO EPSON CORPORATION, Tokyo (JP)

(72) Inventor: Jun ISHIDA, SAPPORO-SHI, HOKKAIDO (JP)

(21) Appl. No.: 19/406,447

(22) Filed: Dec. 2, 2025

(30) Foreign Application Priority Data
Dec. 3, 2024 (JP) 2024-209978

(51) Int. Cl. G06F 3/14; G06F 9/451; G09G 3/00

(52) U.S. Cl. CPC G06F 3/1454; G06F 9/452; G09G 3/001; G09G 2370/02

(57) ABSTRACT

A method of processing information in an information processing apparatus includes displaying an application program window, displaying a data transmission window based on an operation instruction, executing projection processing of transmitting display data for displaying a display screen to a projection apparatus via a web browser and causing the projection apparatus to project the display screen, displaying execution information in the application program window, receiving a browser window stop operation, stopping the projection processing and closing the data transmission window based on the browser window stop operation, and executing display change processing of changing the execution information to stop information.

The present application is based on, and claims priority from JP Application Serial Number 2024-209978, filed December 3, 2024, the disclosure of which is hereby incorporated by reference herein in its entirety.

### BACKGROUND

### Technical Field

The present disclosure relates to a method of processing information in an information processing apparatus.

### Related Art

An image display apparatus to be coupled to a control apparatus such as a computer is known. A projector described in JP-A-2020-64131 is an example of an image display apparatus, and displays an input image based on image information supplied via a connection terminal. The projector can perform display using Miracast. Miracast is a registered trademark. Miracast is a display transmission technique using wireless communication. The projector can mirror a display screen of the control apparatus using Miracast. Miracast is an example of a technique for performing mirroring.

JP-A-2020-64131 is an example of the related art.

However, processing of the display screen when the user stops the mirroring is not considered.

### SUMMARY

A method of processing information in an information processing apparatus according to the present disclosure includes starting an application program configured to control a projection apparatus and displaying an application program window for operating the application program, linking to the projection apparatus through a network for data transfer, displaying, on a web browser, a data transmission window including a data transmission page related to projection based on an operation instruction from the application program, executing projection processing of transmitting display data for displaying a display screen to the projection apparatus via the web browser to instruct the projection apparatus to project the display screen, displaying execution information representing that the projection processing is in operation in the application program window, receiving a browser window stop operation of closing the data transmission window, stopping the projection processing and closing the data transmission window based on the browser window stop operation, and executing display change processing of changing the execution information to stop information representing that the projection processing is not in operation.

A method of processing information in an information processing apparatus according to the present disclosure includes starting an application program configured to control a projection apparatus and displaying an application program window for operating the application program, linking to the projection apparatus through a network for data transfer, displaying, on a web browser, a data transmission window including a data transmission page related to projection based on an operation instruction from the application program, executing projection processing of transmitting display data for displaying a display screen to the projection apparatus via the web browser to instruct the projection apparatus to project the display screen, displaying execution information representing that the projection processing is in operation in the application program window, receiving a stop operation of stopping the projection processing in the application program window, and stopping the projection processing and closing the data transmission window based on the stop operation.

### BRIEF DESCRIPTION OF THE DRAWINGS

FIG. 1 is a diagram illustrating a schematic configuration of a projection system.

FIG. 2 is a diagram illustrating a block configuration of the projection system.

FIG. 3 is a diagram illustrating a schematic configuration of a projection unit.

FIG. 4 is a diagram illustrating a system configuration of the projection system.

FIG. 5 is a diagram illustrating an example of a display screen.

FIG. 6 is a diagram illustrating a control flow executed by a control apparatus.

FIG. 7 is a diagram illustrating an example of the display screen.

FIG. 8 is a diagram illustrating an example of the display screen.

FIG. 9 is a diagram illustrating an example of the display screen.

FIG. 10 is a diagram illustrating a projection image projected on a projection surface.

FIG. 11 is a diagram illustrating an example of a control flow executed by the control apparatus.

FIG. 12 is a diagram illustrating an example of the display screen.

FIG. 13 is a diagram illustrating an example of a control flow executed by the control apparatus.

FIG. 14 is a diagram illustrating an example of a control flow executed by the control apparatus.

FIG. 15 is a diagram illustrating an example of the display screen.

FIG. 16 is a diagram illustrating an example of a control flow executed by the control apparatus.

FIG. 17 is a diagram illustrating an example of the display screen.

### DESCRIPTION OF EMBODIMENTS

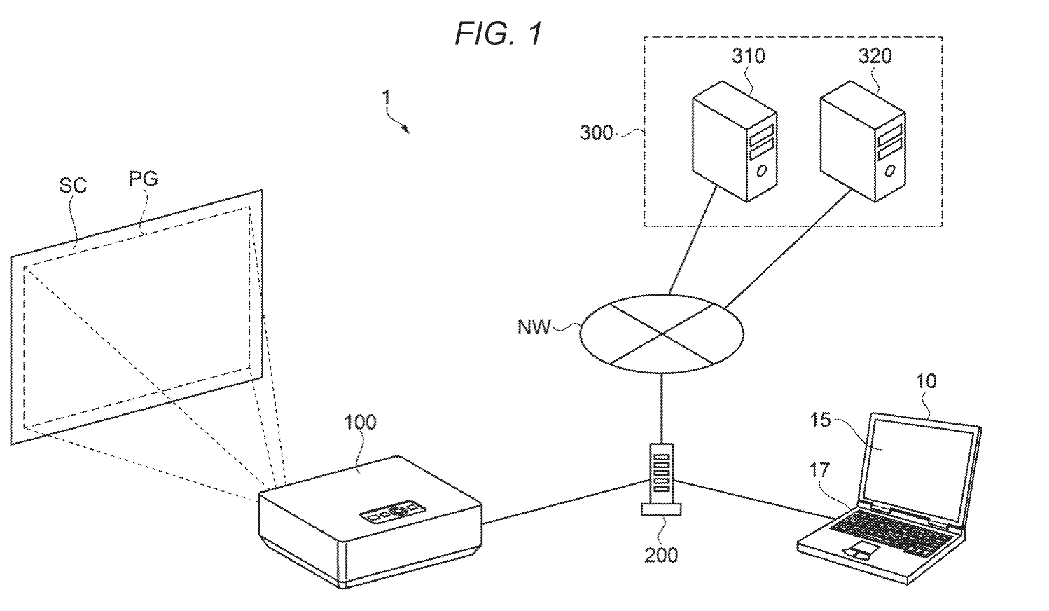

FIG. 1 illustrates a schematic configuration of a projection system 1. The projection system 1 includes a control apparatus 10, a projector 100, a router 200, and a cloud server 300. The projector 100 projects a projection image PG onto a projection surface SC. The cloud server 300 is communicatively connected to the control apparatus 10 via a communication network NW. The projection system 1 illustrated in FIG. 1 includes one control apparatus 10 and one projector 100, but this is not a limitation. The projection system 1 may include a plurality of control apparatuses 10 and a plurality of projectors 100.

The control apparatus 10 is communicatively connected to the projector 100. The control apparatus 10 transmits projection image data to the projector 100. The control apparatus 10 executes mirroring of causing the projector 100 to project, as the projection image PG, a display screen DS displayed on a display 15. The control apparatus 10 may have a function of adjusting an image shape and so on of the projection image PG to be projected onto the projection surface SC by the projector 100. The control apparatus 10 corresponds to an example of an information processing apparatus. The control apparatus 10 is a tablet terminal, a mobile computer, a desktop personal computer, or the like. FIG. 1 illustrates, as a control apparatus 10, a mobile personal computer including the display 15 and an input unit 17.

The control apparatus 10 executes various programs such as a web browser 80 on a dedicated operating system 70. The dedicated operating system 70 is, as an example, the Chrome OS. Chrome is a registered trademark. The dedicated operating system 70 corresponds to an example of an operating system. The dedicated operating system 70 can construct a virtual environment. In the virtual environment, a program that operates on an operating system different from the dedicated operating system 70 is operable. The operating system different from the dedicated operating system 70 is, as an example, Android OS. Android is a registered trademark. The program that operates on the operating system different from the dedicated operating system 70 is, as an example, an Android app.

The display 15 displays a screen including various videos and various images. The display 15 is configured with a liquid crystal panel, an organic electro-luminescence (EL) panel, or the like. The display 15 may have a touch input function of receiving an input operation by a user.

The input unit 17 receives an input operation by the user. FIG. 1 shows a keyboard as the input unit 17, but this is not a limitation. The input unit 17 is configured with a mouse, a touch pad, or the like. When the display 15 has the touch input function, the display 15 functions as the input unit 17.

The projector 100 is disposed at a position facing the projection surface SC. The projector 100 corresponds to an example of a projection apparatus. The projector 100 is communicatively connected to the control apparatus 10. The projector 100 shown in FIG. 1 is communicatively connected to the control apparatus 10 via the router 200, but the projector 100 may be communicatively connected directly to the control apparatus 10. The projector 100 may be communicatively connected to an external apparatus different from the control apparatus 10. The projector 100 receives the projection image data from the control apparatus 10. The projector 100 projects the projection image PG onto the projection surface SC based on the projection image data. The projector 100 may execute mirroring of projecting the display screen DS displayed on the display 15 of the control apparatus 10 based on the projection image data. The projector 100 may project the projection image PG onto the projection surface SC based on OSD data stored in advance. OSD is an abbreviation for on-screen display.

The projection surface SC displays the projection image PG projected from the projector 100. The projection surface SC illustrated in FIG. 1 is formed of a screen, but this is not a limitation. The projection surface SC may be an indoor wall, a ceiling, an outer wall of a building, or the like. A surface shape of the projection surface SC is not limited to a flat surface and may be a three-dimensional shape such as a curved surface, an uneven surface, or a spherical surface.

The router 200 is communication equipment that interconnects the control apparatus 10, the projector 100, and the cloud server 300. The router 200 communicatively connects the control apparatus 10 and the cloud server 300 to each other via the communication network NW. The router 200 communicatively connects the control apparatus 10 and the projector 100 to each other using a predetermined communication protocol. The router 200 may communicatively connect the projector 100 and the cloud server 300 to each other.

The communication network NW communicatively connects the cloud server 300 to the control apparatus 10 and so on. The communication network NW is, as an example, a wide area network (WAN).

The cloud server 300 is a virtual server that operates in a cloud computing environment. The cloud server 300 is a service that uses a single virtualized server or a plurality of virtualized servers via the Internet. The cloud server 300 illustrated in FIG. 1 includes a web server 310 and a WebSocket server 320.

The web server 310 provides display of HTML and objects to the web browser 80 of client software. FIG. 1 virtually illustrates the web server 310. The web server 310 provides web apps to the web browser 80 of the control apparatus 10 based on an instruction from the control apparatus 10. When the control apparatus 10 or the like stores web apps in advance, the projection system 1 is not required to include the web server 310.

The WebSocket server 320 is a server that performs data communication with the web app on the web browser 80 in accordance with the standard of WebSocket. FIG. 1 virtually illustrates the WebSocket server 320. The WebSocket server 320 is used as an SDP exchanging signaling server when streaming distribution of shared data or the like is performed using Web Real-Time Communication (WebRTC) technology. SDP is an abbreviation for Session Description Protocol.

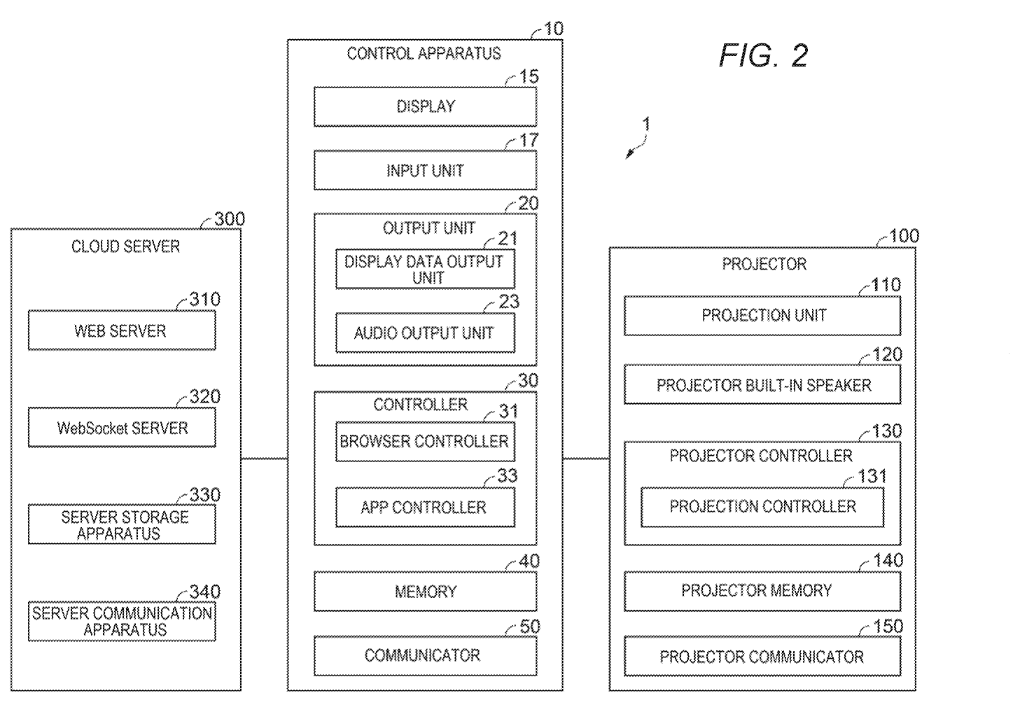

FIG. 2 illustrates a block configuration of the projection system 1. FIG. 2 illustrates a block configuration of the control apparatus 10, the projector 100, and the cloud server 300 provided to the projection system 1. FIG. 2 illustrates the projection system 1 in which the router 200 is omitted.

The control apparatus 10 includes the display 15, the input unit 17, an output unit 20, a controller 30, a memory 40, and a communicator 50. The control apparatus 10 includes a built-in speaker (not shown).

The display 15 displays the display screen DS based on control of the controller 30. The display 15 is coupled to a display data output unit 21 of the output unit 20. The display data output unit 21 will be described later. The display 15 illustrated in FIG. 2 is provided to the control apparatus 10, but this is not a limitation. The display 15 may be a display panel externally attached to the control apparatus 10.

The input unit 17 receives various input operations by the user. The input unit 17 generates an input signal corresponding to an input operation and outputs the input signal to the controller 30. The input unit 17 illustrated in FIG. 2 is provided to the control apparatus 10, but this is not a limitation. The input unit 17 may be an input device externally attached to the control apparatus 10.

The output unit 20 outputs, to the display 15 and so on, various types of generated data generated by the controller 30 and so on. The output unit 20 is configured with various circuits, output terminals, and so on. The output unit 20 corresponds to an example of an output unit. The output unit 20 includes a display data output unit 21 and an audio output unit 23.

The display data output unit 21 outputs, to the display 15, video data for displaying a video. The video data includes image data for displaying a still image. The video data belongs to the generated data. The display data output unit 21 may output the video data and so on to a display panel externally attached to the control apparatus 10.

The audio output unit 23 outputs audio data related to an audio. The audio data belongs to the generated data. The audio output unit 23 is coupled to a built-in speaker or the like (all not shown). The speaker or the like may be incorporated in the control apparatus 10 or may be externally attached to the control apparatus 10. The audio output unit 23 outputs the audio data in a wired or wireless manner.

The controller 30 is an apparatus controller that controls each part of the control apparatus 10. The controller 30 is, as an example, a processor including a central processing unit (CPU). The controller 30 is configured with a single processor or a plurality of processors. The dedicated operating system 70 operates in the controller 30. The controller 30 executes various programs on the dedicated operating system 70. The controller 30 functions as various functional units by executing the various programs. As an example, the controller 30 functions as a browser controller 31 and an app controller 33. The controller 30 may function as functional units other than the browser controller 31 and the app controller 33.

The browser controller 31 causes the web browser 80 to operate on the dedicated operating system 70 to display various web pages. The browser controller 31 causes the web app to operate on the web browser 80 to execute a function of the web app. As an example, the browser controller 31 causes a capture app 84, which is the web app, to operate on the web browser 80 to capture at least one of video data and audio data. The capture app 84 will be described later in detail.

The app controller 33 causes apps to operate on the dedicated operating system 70 or on the virtual environment. The app controller 33 causes apps having a specification compatible with the dedicated operating system 70 to operate on the dedicated operating system 70. The app controller 33 causes apps having a specification different from the specification compatible with the dedicated operating system 70 to operate on the virtual environment. The virtual environment is constructed on a virtual device 90 that operates on the dedicated operating system 70. The virtual device 90 will be described later.

The memory 40 stores various programs, various data, and so on. The memory 40 stores an apparatus control program, various web apps, various apps, and so on. The memory 40 stores various data and so on generated by the controller 30. The memory 40 is configured with a volatile semiconductor memory such as a random access memory (RAM) and a nonvolatile memory such as a read only memory (ROM) or a flash memory. The memory 40 may function as a work area for the controller 30. The memory 40 corresponds to an example of a memory.

The communicator 50 is a communication interface circuit that communicates with the projector 100, the cloud server 300, and so on. The communicator 50 is communicatively connected wirelessly to the projector 100 and so on in accordance with a predetermined communication protocol. The communicator 50 includes a wireless communication port. The wireless communication port is a wireless local area network (LAN) communication port or the like. The communicator 50 may be communicatively connected to the projector 100 and so on in a wired manner. The communicator 50 includes a wired connector such as a universal serial bus (USB). The communicator 50 transmits various control signals, the projection image data, and so on to the projector 100. The projection image data includes the video data, the audio data, and so on. The communicator 50 receives various data, response signals, and so on from the cloud server 300 and so on.

The projector 100 includes a projection unit 110, a projector built-in speaker 120, a projector controller 130, a projector memory 140, and a projector communicator 150.

The projection unit 110 projects image light based on the projection image data onto the projection surface SC in an enlarged manner. The projection unit 110 projects the projection image PG onto the projection surface SC based on control of the projector controller 130. The projection unit 110 projects a moving image, a still image, an OSD image, and so on as the projection image PG based on the video data and so on contained in the projection image data. The OSD image is an image representing various types of setting, operation information, and so on relating to the projector 100.

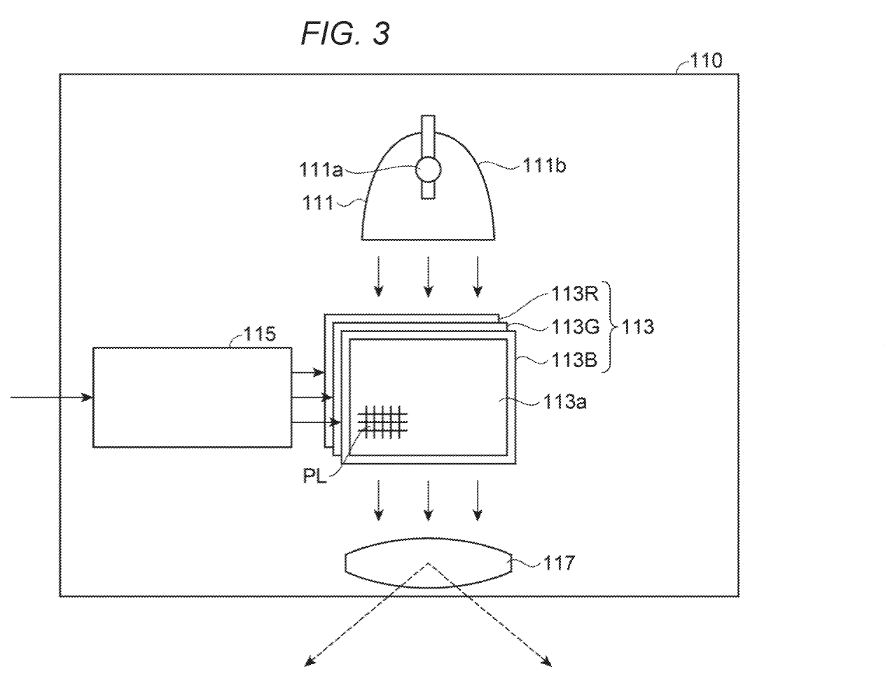

FIG. 3 illustrates a schematic configuration of the projection unit 110. FIG. 3 illustrates an example of the projection unit 110. The projection unit 110 includes a light source 111, three liquid crystal light valves 113, a light valve driver 115, and a projection lens 117.

The light source 111 emits light to the liquid crystal light valves 113. The light source 111 includes a light source unit 111a, a reflector 111b, an integrator optical system (not illustrated), and a color separation optical system (not illustrated). The light source unit 111a emits the light. The light source unit 111a is configured with a xenon lamp, an ultra-high-pressure mercury lamp, a light emitting diode (LED), or a laser light source. The light source unit 111a emits the light based on control by the projector controller 130. The reflector 111b reduces variations in an emission direction of the light emitted by the light source unit 111a. The integrator optical system reduces variations in a luminance distribution of the light emitted by the light source unit 111a. The light having passed through the reflector 111b is incident on the color separation optical system. The color separation optical system separates the incident light into red, green, and blue colored light components.

The liquid crystal light valves 113 modulate the light emitted from the light source 111. The liquid crystal light valves 113 modulate the light to thereby generate the projection image PG and so on. The liquid crystal light valves 113 are each configured with a transmissive liquid crystal panel in which liquid crystal is sealed between a pair of transparent substrates. The liquid crystal light valves 113 each have a rectangular pixel region 113a including a plurality of pixels PL arranged in a matrix. In each of the liquid crystal light valves 113, a drive voltage is applied to the liquid crystal for each of the pixels PL. The projection unit 110 illustrated in FIG. 3 includes the three liquid crystal light valves 113. The projector 100 has a configuration in which the liquid crystal light valves 113 are provided and the transmissive liquid crystal panels are used, but this is not a limitation. The projector 100 may include reflective liquid crystal panels or liquid-crystal-on-silicon (LCOS) liquid crystal panels. The projector 100 may have a configuration in which one or more digital mirror devices (DMDs) are provided.

The three liquid crystal light valves 113 are a red-light liquid crystal light valve 113R, a green-light liquid crystal light valve 113G, and a blue-light liquid crystal light valve 113B. A red colored light component separated by the color separation optical system is incident on the red-light liquid crystal light valve 113R. A green colored light component separated by the color separation optical system is incident on the green-light liquid crystal light valve 113G. A blue colored light component separated by the color separation optical system is incident on the blue-light liquid crystal light valve 113B.

The light valve driver 115 applies the drive voltage to each of the pixels PL based on the projection image data received from the projector controller 130. The light valve driver 115 is, for example, a control circuit. The drive voltage is supplied by a drive source (not illustrated). The light valve driver 115 may apply the drive voltage to each of the pixels PL based on projection image data corrected by a projection controller 131 described later. When the light valve driver 115 applies the drive voltage to each of the pixels PL, each of the pixels PL is set to a light transmittance based on the projection image data. The light emitted from the light source 111 is modulated by being transmitted through the pixel region 113a. The three liquid crystal light valves 113 form color component images for the respective colored light.

The projection lens 117 combines the color component images formed by the liquid crystal light valves 113 to project the result in an enlarged manner. The projection lens 117 projects the projection image PG onto the projection surface SC. The projection image PG is a multi-color image obtained by combining the color component images.

The projector built-in speaker 120 illustrated in FIG. 2 outputs an audio based on the audio data contained in the projection image data. The projector built-in speaker 120 receives the audio data from the projector controller 130 to output an audio corresponding to the audio data. The projector 100 illustrated in FIG. 2 includes the projector built-in speaker 120, but this is not a limitation. The projector 100 may include an external speaker. The external speaker outputs an audio based on the audio data.

The projector controller 130 is a projector controller that controls each unit of the projector 100. The projector controller 130 is, as an example, a processor including a CPU. The projector controller 130 is configured with a single processor or a plurality of processors. The projector controller 130 functions as the projection controller 131 by executing firmware. The projector controller 130 may function as a functional unit other than the projection controller 131.

The projection controller 131 controls projection by the projection unit 110. The projection controller 131 causes the projection unit 110 to project the projection image PG based on the video data contained in the projection image data transmitted from the control apparatus 10. The projection controller 131 causes the projector built-in speaker 120 to output an audio based on the audio data contained in the projection image data. The projection controller 131 synchronizes the projection image PG projected from the projection unit 110 and the audio output from the projector built-in speaker 120 with each other. The projection controller 131 performs various types of correction processing such as keystone correction on the video data.

The projector memory 140 stores the firmware, various data, and so on. The projector memory 140 stores the projection image data transmitted from the control apparatus 10, correction data for correcting the video data contained in the projection image data, and so on. The projector memory 140 includes a volatile semiconductor memory such as a RAM and a nonvolatile memory such as a ROM or a flash memory.

The projector communicator 150 is a communication interface circuit that communicates with the control apparatus 10, an external apparatus, and so on. The projector communicator 150 is communicatively connected to the control apparatus 10 and so on wirelessly in accordance with a predetermined communication protocol. The projector communicator 150 includes a wireless communication port. The wireless communication port is a wireless LAN communication port or the like. The projector communicator 150 may be communicatively connected to the control apparatus 10 and so on in a wired manner. The projector communicator 150 includes a wired connector such as USB. The projector communicator 150 receives the projection image data, the control signals, and so on from the control apparatus 10. The projector communicator 150 transmits various data such as projector setting information to the control apparatus 10 and so on.

The cloud server 300 includes the web server 310, the WebSocket server 320, a server storage apparatus 330, and a server communication apparatus 340. The web server 310, the WebSocket server 320, the server storage apparatus 330, and the server communication apparatus 340 are implemented in a single apparatus or a plurality of apparatuses.

The server storage apparatus 330 stores various programs, various data, and so on. The server storage apparatus 330 stores web pages, web apps, and so on provided from various web servers 310. The server storage apparatus 330 is formed of a magnetic recording medium such as a hard disk drive (HDD). The server storage apparatus 330 may be configured with a volatile semiconductor memory such as a RAM, and a nonvolatile memory such as a ROM or a flash memory.

The server communication apparatus 340 is a communication interface circuit that communicates with the control apparatus 10 and so on. The server communication apparatus 340 is communicatively connected to the control apparatus 10 and so on in a wired or wireless manner in accordance with a predetermined communication protocol. The server communication apparatus 340 includes a wired connector, a wireless communication port, and so on. The wired connector is a USB connector, a LAN connector, or the like. The wireless communication port is a Wi-Fi communication port, a Bluetooth communication port, or the like. Wi-Fi and Bluetooth are registered trademarks. The server communication apparatus 340 transmits the web app and so on to the control apparatus 10. The server communication apparatus 340 receives various signals transmitted from the control apparatus 10.

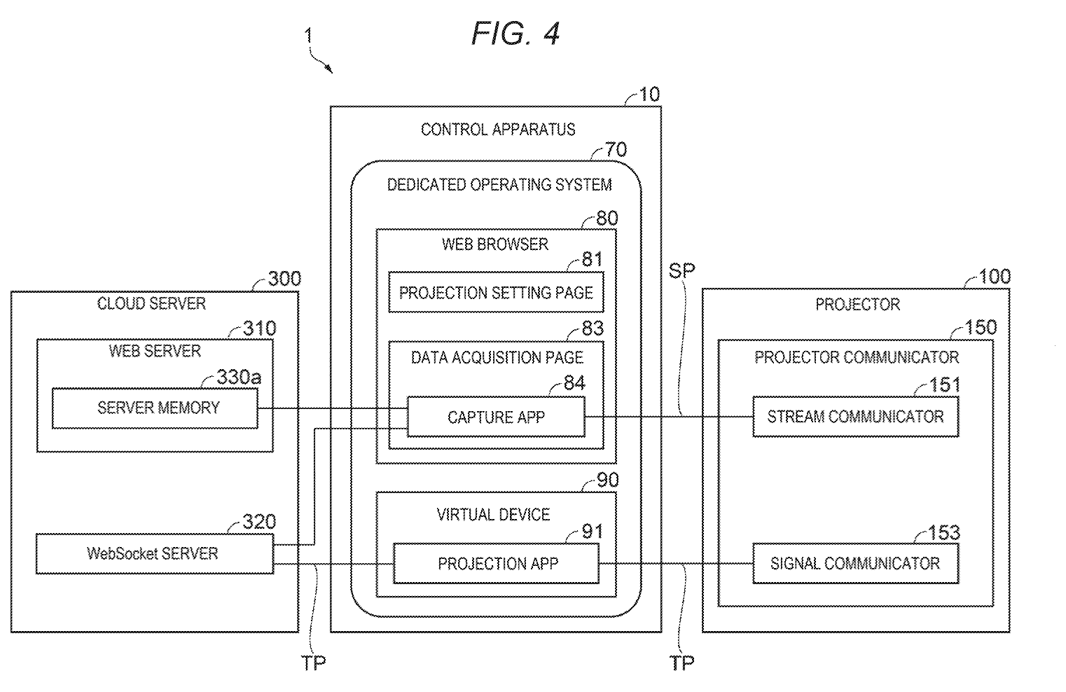

FIG. 4 illustrates a system configuration of the projection system 1. FIG. 4 illustrates the control apparatus 10, the projector 100, and the cloud server 300.

In the control apparatus 10, the dedicated operating system 70 operates. The dedicated operating system 70 is, as an example, the Chrome OS. The controller 30 of the control apparatus 10 causes the dedicated operating system 70 to operate. Applications compatible with the dedicated operating system 70 are operable on the dedicated operating system 70. The web browser 80 and the virtual device 90 operate on the dedicated operating system 70 illustrated in FIG. 4. Applications other than the web browser 80 and the virtual device 90 may operate on the dedicated operating system 70.

The web browser 80 is software to be connected to the web server 310. The web browser 80 operates on the dedicated operating system 70. The web browser 80 is, as an example, Chrome. The web browser 80 displays various web pages in a browser window BW including a tab window TW. The web browser 80 acquires the web pages from the web server 310. The web pages may include web apps that operate in the web pages. The web browser 80 displays a projection setting page 81 and a data acquisition page 83 in the browser window BW or the tab window TW. In the data acquisition page 83, the capture app 84 is activated.

The projection setting page 81 receives a mirroring start instruction operation for instructing the start of mirroring. When the user performs the mirroring start instruction operation on the projection setting page 81, the projection setting page 81 sets the projector 100 to execute mirroring. The projection setting page 81 is an example of the web page. The web browser 80 acquires the projection setting page information related to the projection setting page 81 from the web server 310. The web browser 80 displays the projection setting page 81 in the browser window BW or the tab window TW based on the projection setting page information. The projection setting page 81 corresponds to an example of a setting page.

The data acquisition page 83 causes the capture app 84 to operate to thereby acquire the shared data. The data acquisition page 83 is an example of the web page. The web browser 80 acquires data acquisition page information related to the data acquisition page 83 from the web server 310. The web browser 80 displays the data acquisition page 83 in the browser window BW or the tab window TW based on the data acquisition page information. In the data acquisition page 83, the capture app 84 is activated. The data acquisition page 83 causes the capture app 84 to operate to acquire the shared data.

The capture app 84 is activated on a data acquisition page 83 displayed on the web browser 80. The web browser 80 acquires the data acquisition page 83 including the capture app 84 from the web server 310. The capture app 84 captures, as the shared data, the generated data output from the output unit 20 of the control apparatus 10. The generated data includes video data output from the display data output unit 21. The video data is data for causing the display 15 to display the display screen DS. The video data corresponds to an example of display data. The shared data may include audio data output from the audio output unit 23. The shared data is transmitted to the projector 100 via a stream distribution path SP as the projection image data. The capture app 84 may transmit the shared data to a projection app 91. The capture app 84 corresponds to an example of a web application.

The virtual device 90 is a virtual device that operates on the dedicated operating system 70. The virtual device 90 is an example of an emulator that operates on the dedicated operating system 70. The virtual device 90 functions as a device that causes an operating system different from the dedicated operating system 70 to operate on the dedicated operating system 70. The virtual device 90 provides a virtual environment on the dedicated operating system 70. The virtual device 90 is, as an example, a device where the Android OS operates. It becomes possible to run, on the virtual device 90, applications that operate on the operating system different from the dedicated operating system 70. The applications that operate on the operating system different from the dedicated operating system 70 are Android apps. The projection app 91 illustrated in FIG. 4 is an example of the Android app.

The projection app 91 is software that controls the projector 100. The projection app 91 corresponds to an example of the application program. The projection app 91 is stored in advance in the memory 40. The projection app 91 causes the projector 100 to project various projection images PG. The projection app 91 transmits various control signals to the projector 100, the cloud server 300, and so on. The projection app 91 receives response signals and so on from the projector 100, the cloud server 300, and so on. The projection app 91 causes the capture app 84 to acquire the shared data. The projection app 91 causes the capture app 84 to transmit the shared data to the projector 100 as the projection image data. The projection app 91 may cause the capture app 84 to transmit the shared data to the projection app 91.

The projection app 91 controls display by the web browser 80. The projection app 91 controls a display mode of the browser window BW or the tab window TW that displays the projection setting page 81 and the data acquisition page 83. The projection app 91 controls the display mode of the browser window BW or the tab window TW to thereby allow the user to confirm the situation of the mirroring and so on. The projection app 91 transmits, to the web browser 80, setting information for controlling the display mode of the browser window BW or the tab window TW, and so on to thereby control the display mode.

The projection app 91 controls the display mode of a UI screen 170 of the projection app 91 based on various signals transmitted from the web browser 80. The UI screen 170 will be described later. By controlling the display mode of the UI screen 170, the projection app 91 can allow the user to confirm the situation of the mirroring and so on.

The projection app 91 that operates on the virtual device 90 transmits or receives various control signals and so on to and from the dedicated operating system 70 via various application programming interfaces (API). The API is different depending on a version or the like of the operating system that operates on the virtual device 90. Depending on the version of the operating system that operates on the virtual device 90, it becomes difficult for the projection app 91 to control the projector 100 in some cases. The projection app 91 transmits, as the projection image data, the shared data to the projector 100 using the functions of the web browser 80 and the cloud server 300.

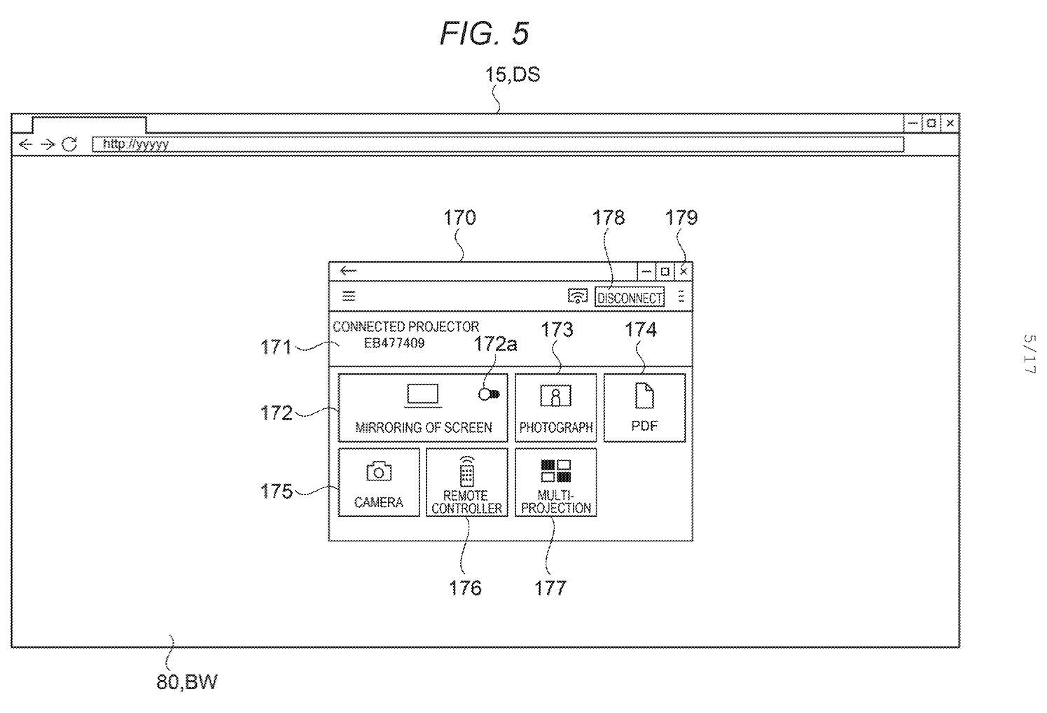

FIG. 5 illustrates an example of the display screen DS. The display screen DS is displayed on the display 15. The display screen DS illustrated in FIG. 5 represents the display screen DS at the time when the control apparatus 10 activates the projection app 91. The display screen DS includes a UI screen 170 of the projection app 91. UI is an abbreviation for a user interface. FIG. 5 illustrates the UI screen 170 displayed on the browser window BW of the web browser 80.

The UI screen 170 displays a plurality of icons and so on. The UI screen 170 includes a projector name display 171, a mirroring reception icon 172, a photograph display reception icon 173, a document display reception icon 174, a camera image display reception icon 175, a remote controller function reception icon 176, a multi-projection reception icon 177, a disconnection reception icon 178, and a termination reception icon 179.

The projector name display 171 displays a projector name of the projector 100 connected to the control apparatus 10. The projector name display 171 displays the projector name based on model information or the like of the projector 100 acquired from the projector 100.

The mirroring reception icon 172 receives a mirroring instruction operation by the user. When the user executes a predetermined operation on the mirroring reception icon 172, the mirroring reception icon 172 receives the mirroring instruction operation. When the projection app 91 receives the mirroring instruction operation, the projection app 91 generates a mirroring control signal corresponding to the mirroring instruction operation. The mirroring reception icon 172 includes a switch icon 172a.

The switch icon 172a represents whether mirroring is in operation in the projector 100. By checking the display of the switch icon 172a, the user can determine whether mirroring is in operation in the projector 100. The switch icon 172a illustrated in FIG. 5 indicates that mirroring is not in operation. The switch icon 172a may receive the mirroring instruction operation by the user.

The photograph display reception icon 173 receives a photograph display instruction by the user. When the user executes a predetermined operation on the photograph display reception icon 173, the photograph display reception icon 173 receives the photograph display instruction. When the projection app 91 receives the photograph display instruction, the projection app 91 performs photograph display processing of causing the projector 100 to project a photograph image stored by the control apparatus 10. The projection app 91 transmits photograph image data for displaying the photograph image to the projector 100 to cause the projector 100 to project the photograph image as the projection image PG.

The document display reception icon 174 receives a document display instruction by the user. When the user executes a predetermined operation on the document display reception icon 174, the document display reception icon 174 receives the document display instruction. When the projection app 91 receives the document display instruction, the projection app 91 performs document display processing of causing the projector 100 to project a PDF file or the like stored by the control apparatus 10. The projection app 91 transmits, as an example, PDF data for displaying a PDF image to the projector 100 to cause the projector 100 to project the PDF image as the projection image PG.

The camera image display reception icon 175 receives a camera image display instruction by the user. When the control apparatus 10 includes an imaging device such as a camera, the camera image display reception icon 175 is operable. When the user executes a predetermined operation on the camera image display reception icon 175, the camera image display reception icon 175 receives the camera image display instruction. When the projection app 91 receives the camera image display instruction, the projection app 91 performs camera image display processing of causing the projector 100 to project a captured image captured by the imaging device. The projection app 91 transmits imaging data for displaying the captured image to the projector 100 to cause the projector 100 to project the captured image as the projection image PG.

The remote controller function reception icon 176 receives a remote controller function operation instruction by the user. When the user executes a predetermined operation on the remote controller function reception icon 176, the remote controller function reception icon 176 receives the remote controller function operation instruction. When the projection app 91 receives the remote controller function operation instruction, the projection app 91 causes a remote controller image representing a remote controller for operating the projector 100 to be displayed on the projection image PG. When the user performs an input operation on the remote controller image, control corresponding to the input operation can be performed on the projector 100.

The multi-projection reception icon 177 receives a multi-projection instruction by the user. The multi-projection reception icon 177 is operable when a plurality of projectors 100 is connected to the control apparatus 10. When the user executes a predetermined operation on the multi-projection reception icon 177, the multi-projection reception icon 177 receives the multi-projection instruction. The projection app 91 executes multi-projection of causing the plurality of projectors 100 connected to the control apparatus 10 to project the projection image PG onto the projection surface SC.

The disconnection reception icon 178 receives a disconnection instruction by the user. When the user executes a predetermined operation on the disconnection reception icon 178, the disconnection reception icon 178 receives the disconnection instruction. When the projection app 91 receives the disconnection instruction, the projection app 91 disconnects the communicative connection between the control apparatus 10 and the projector 100.

The termination reception icon 179 receives an app termination operation by the user. When the user performs a predetermined operation on the termination reception icon 179, the termination reception icon 179 receives the app termination operation. When the projection app 91 receives the app termination operation, the projection app 91 stops operating. Then, the UI screen 170 is hidden.

The stream distribution path SP illustrated in FIG. 4 is a path through which real-time communication between the web browser 80 and the projector 100 is performed. Through the stream distribution path SP, the communication is performed using, as an example, WebRTC technology. The web browser 80 can transmit the shared data to the projector 100 via the stream distribution path SP. By the web browser 80 transmitting the shared data to the projector 100 via the stream distribution path SP, the control apparatus 10 can transmit the shared data to the projector 100 without degrading the quality of the shared data. The stream distribution path SP corresponds to an example of a browser communication path.

A TCP/IP communication path TP is a path for performing communication using Transmission Control Protocol/Internet Protocol (TCP/IP). The TCP/IP communication path TP and the stream distribution path SP are communication paths different from each other. The projection app 91 transmits various control signals to the projector 100 via the TCP/IP communication path TP. The projection app 91 receives control signals from the projector 100 via the TCP/IP communication path TP. The projection app 91 may transmit the shared data to the projector 100 via the TCP/IP communication path TP. When the shared data is transmitted to the projector 100 via the TCP/IP communication path TP, there is a possibility that degradation of the quality of the shared data occurs depending on a situation of the virtual device 90. The shared data is preferably transmitted to the projector 100 via the stream distribution path SP. The TCP/IP communication path TP corresponds to an example of a signal communication path.

The projector communicator 150 of the projector 100 includes a stream communicator 151 and a signal communicator 153.

The stream communicator 151 is communicatively connected to the capture app 84 via the stream distribution path SP. The stream communicator 151 is compatible with the WebRTC technology. The stream communicator 151 receives the shared data transmitted from the capture app 84 with real-time communication.

The signal communicator 153 is communicatively connected to the projection app 91 via the TCP/IP communication path TP. The signal communicator 153 receives a control signal from the projection app 91. The signal communicator 153 transmits the control signal generated by the projector 100 to the projection app 91. By the signal communicator 153 transmitting and receiving the control signal between the projection app 91 and the projector 100, the projection app 91 can control the projector 100.

The web server 310 provided to the cloud server 300 includes a server memory 330a. The server memory 330a is a part of the server storage apparatus 330. The server memory 330a stores web page information related to various web pages. The web page information includes web app information related to various web apps. The web server 310 provides the web browser 80 with the web page information stored in the server memory 330a.

The WebSocket server 320 receives various control signals transmitted from the projection app 91 via the TCP/IP communication path TP. The control signal transmitted from the projection app 91 includes a web page request. The web page request is, as an example, a signal that instructs transmission of a web page including the web app from the web server 310 to the web browser 80. When the WebSocket server 320 receives the web page request, the WebSocket server 320 transmits the web page request to the web server 310. The web server 310 transmits the web page information to the web browser 80 based on the web page request.

In the projection system 1 shown in FIG. 4, the web server 310 provided to the cloud server 300 provides various web pages, but this is not a limitation. The projection setting page information related to the projection setting page 81 and the data acquisition page information related to the data acquisition page 83 may be stored in advance in the memory 40 of the control apparatus 10 or the projector memory 140 of the projector 100. The projection setting page information and the data acquisition page information are examples of the web page information. When the projection setting page information and so on are stored in the memory 40, the web browser 80 acquires the projection setting page information and so on from the memory 40. At this time, the controller 30 has a virtual server function equivalent to that of the cloud server 300. When the projection setting page information and so on are stored in the projector memory 140, the web browser 80 acquires the projection setting page information and so on from the projector 100. At this time, the projector controller 130 has a virtual server function equivalent to that of the cloud server 300. When the projection setting page information and so on are stored in advance in the memory 40 or the projector memory 140, the projection system 1 is not required to include the cloud server 300.

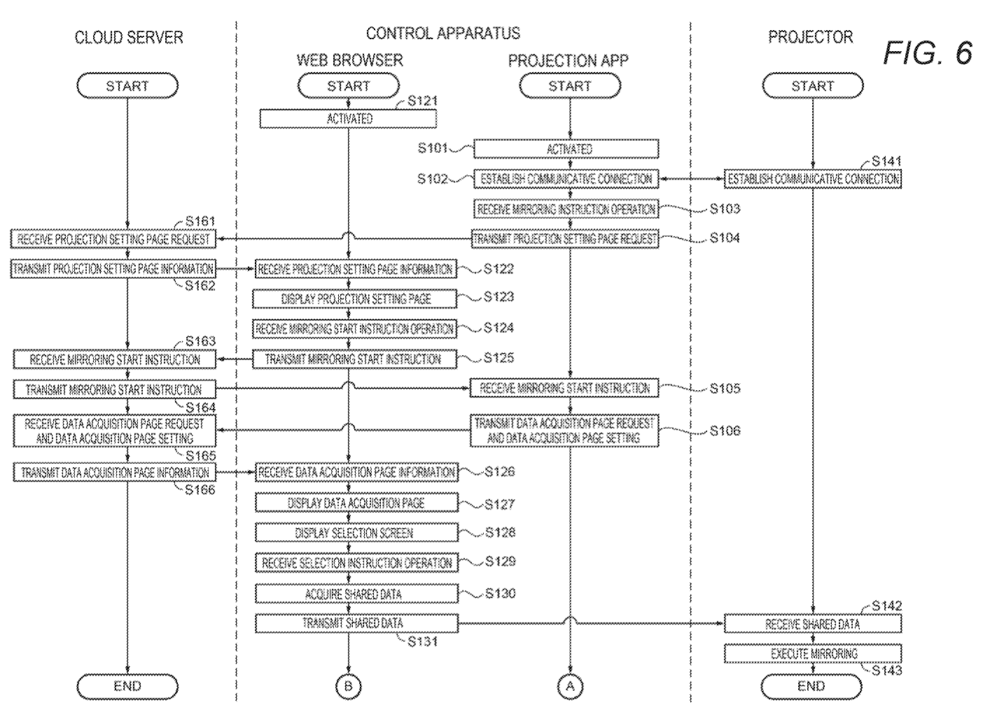

FIG. 6 illustrates a control flow executed in the projection system 1. FIG. 6 illustrates a control flow executed by the control apparatus 10, the projector 100, and the cloud server 300. The control flow executed by the control apparatus 10 corresponds to an example of an information processing method. The control apparatus 10 executes the control flow to thereby execute mirroring of causing the projector 100 to project the display screen DS displayed on the display 15.

The projection app 91 is activated in step S101. When the input unit 17 of the control apparatus 10 receives a predetermined operation by the user, the control apparatus 10 activates the projection app 91. The projection app 91 runs on the virtual device 90. The projection app 91 is executed on a virtual environment. When the projection app 91 is activated, the UI screen 170 for operating the projection app 91 is displayed on the display screen DS. The UI screen 170 corresponds to an example of an application program window.

The web browser 80 is activated in step S121 before or after the projection app 91 is activated. FIG. 6 illustrates when the web browser 80 is activated before the projection app 91 is activated. When the user performs a predetermined input operation using the input unit 17, the browser controller 31 receives the browser activation instruction and then executes the browser activation processing of activating the web browser 80. The web browser 80 is activated before the projection app 91 receives the mirroring instruction operation. When the projection app 91 and the web browser 80 are activated, the UI screen 170 and the browser window BW illustrated in FIG. 5 are displayed on the display screen DS.

After being activated, the projection app 91 establishes communicative connection to the projector 100 in step S102. The projection app 91 transmits, to the projector 100, a control signal such as a connection request via the TCP/IP communication path TP to establish the communicative connection to the projector 100.

After the projection app 91 is activated, the projector 100 establishes communicative connection to the control apparatus 10 in step S141. The projector 100 receives the control signal such as the connection request from the projection app 91 via the TCP/IP communication path TP. The projector 100 transmits various data such as the model information to establish the communicative connection to the control apparatus 10.

After establishing the communicative connection to the projector 100, the projection app 91 receives the mirroring instruction operation in step S103. When the projection app 91 is activated, the projection app 91 causes the display 15 to display the UI screen 170 as shown in FIG. 5. When the user executes the mirroring instruction operation on the mirroring reception icon 172 in the UI screen 170 displayed on the display 15, the mirroring reception icon 172 receives the mirroring instruction operation.

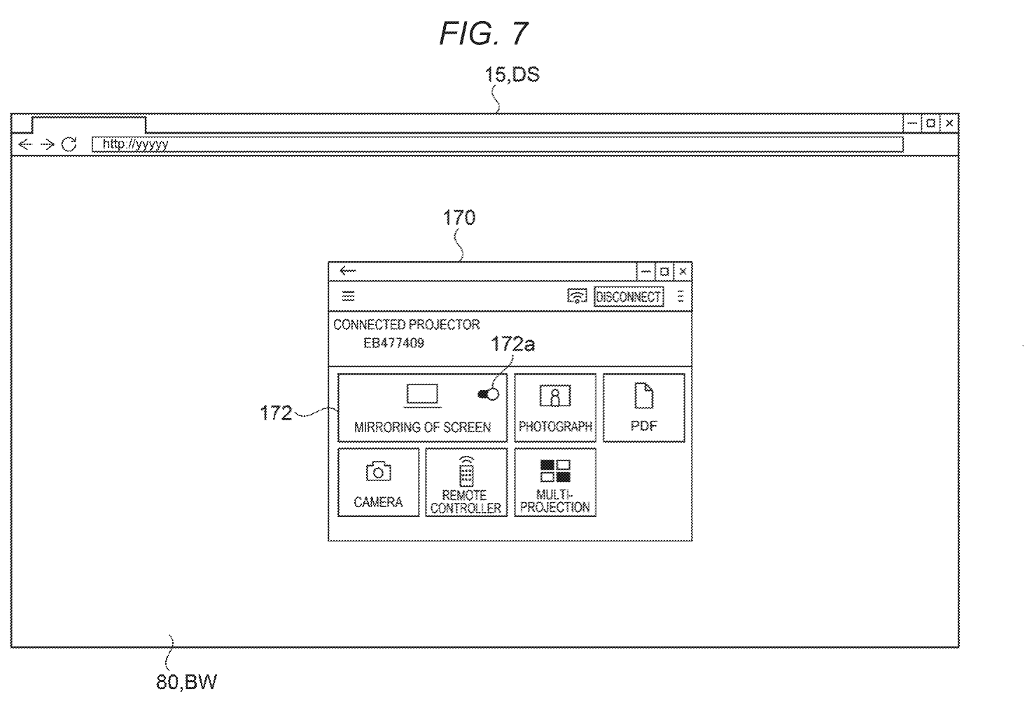

FIG. 7 illustrates an example of the display screen DS. The display screen DS is displayed on the display 15. The display screen DS illustrated in FIG. 7 includes the browser window BW of the web browser 80 and the UI screen 170 of the projection app 91. The display screen DS shown in FIG. 7 represents the display screen DS when the user executes the mirroring instruction operation on the mirroring reception icon 172.

When the user executes the mirroring instruction operation on the mirroring reception icon 172, the display mode of the switch icon 172a is changed as illustrated in FIG. 7. The app controller 33 performs display mode change processing of changing the display mode. The switch icon 172a slides to the right to be switched to an execution indication indicating that the mirroring processing is in operation. The execution indication corresponds to an example of execution information.

As shown in FIG. 6, when receiving the mirroring instruction operation, the projection app 91 transmits the projection setting page request to the cloud server 300 in step S104. The projection app 91 transmits the projection setting page request to thereby display the projection setting page 81 in the tab window TW of the web browser 80. The projection setting page window 81w including the projection setting page 81 is displayed as the tab window TW. The projection app 91 causes the projection setting page window 81w to be displayed as the tab window TW based on the mirroring instruction operation. The projection app 91 may transmit the projection setting page request directly to the cloud server 300 or may transmit the projection setting page request to the cloud server 300 via the web browser 80.

When the projection app 91 transmits the projection setting page request, the cloud server 300 receives the projection setting page request in step S161. The web server 310 provided to the cloud server 300 receives the projection setting page request. The web server 310 acquires the projection setting page information based on the projection setting page address contained in the projection setting page request.

After receiving the projection setting page request, the cloud server 300 transmits the projection setting page information to the web browser 80 in step S162. The web server 310 provided to the cloud server 300 transmits the projection setting page information to the web browser 80.

When the cloud server 300 transmits the projection setting page information, the web browser 80 receives the projection setting page information in step S122.

When receiving the projection setting page information, the web browser 80 displays the projection setting page 81 in step S123. The browser controller 31 executes projection setting page display processing of displaying, as the tab window TW, the projection setting page window 81w including the projection setting page 81 based on the projection setting page information. The web browser 80 displays, as the tab window TW, the projection setting page window 81w in the first display size.

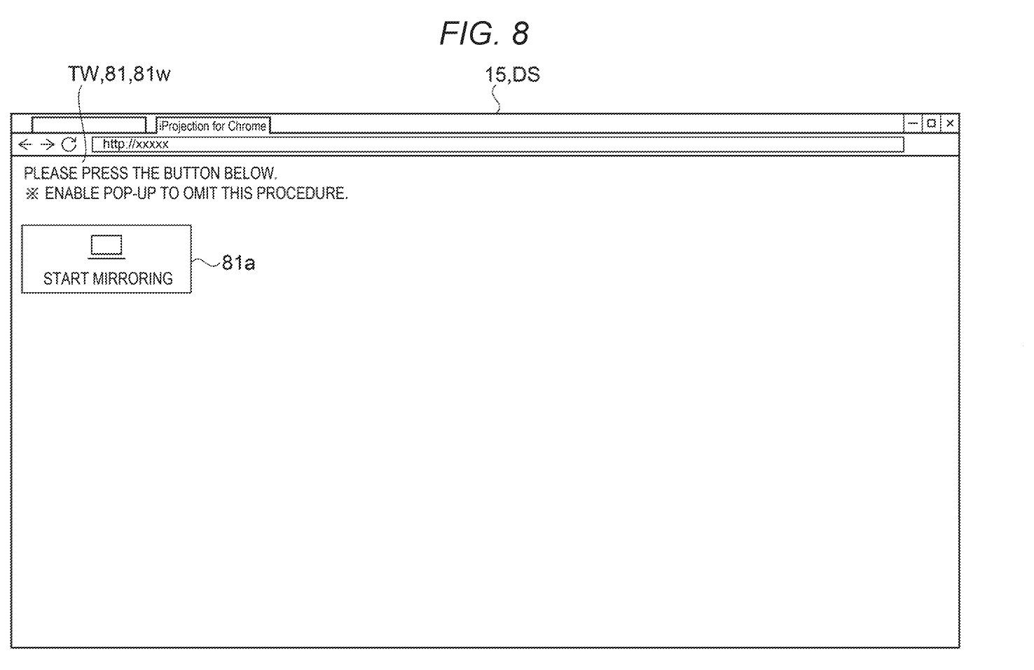

FIG. 8 illustrates an example of the display screen DS. The display screen DS is displayed on the display 15. The display screen DS shown in FIG. 8 represents the display screen DS that is displayed when the browser controller 31 executes the projection setting page display processing based on the projection setting page information.

The web browser 80 shown in FIG. 8 displays, as the tab window TW, the projection setting page window 81w that displays the projection setting page 81. The projection setting page 81 displayed in the projection setting page window 81w receives an input operation related to mirroring of projecting the display screen DS. The projection setting page window 81w includes a mirroring start icon 81a.

The projection setting page window 81w displayed as the tab window TW is displayed in the first display size. The first display size is, as an example, a full-screen size of the display 15. The first display size may be a size of the browser window BW when the web browser 80 is activated in step S121. The first display size is not limited as long as the mirroring start icon 81a can be displayed.

As illustrated in FIG. 6, after displaying the projection setting page 81, the web browser 80 receives the mirroring start instruction operation in step S124. When the user performs the mirroring start instruction operation on the mirroring start icon 81a, the projection setting page 81 receives the mirroring start instruction operation.

When the web browser 80 receives the mirroring start instruction operation, the web browser 80 transmits the mirroring start instruction to the cloud server 300 in step S125.

When the web browser 80 transmits the mirroring start instruction, the cloud server 300 receives the mirroring start instruction in step S163.

When the cloud server 300 receives the mirroring start instruction, the cloud server 300 transmits the mirroring start instruction to the projection app 91 in step S164.

When the cloud server 300 transmits the mirroring start instruction, the projection app 91 receives the mirroring start instruction in step S105.

When receiving the mirroring start instruction, the projection app 91 transmits a data acquisition page request and data acquisition page setting to the cloud server 300 in step S106. The projection app 91 causes the data acquisition page window 83w including the data acquisition page 83 to be displayed as the tab window TW by transmitting the data acquisition page request and the data acquisition page setting. The web browser 80 displays the data acquisition page window 83w as the tab window TW based on the mirroring start instruction operation.

The data acquisition page setting is display setting when the web browser 80 displays the data acquisition page window 83w as the tab window TW. The projection app 91 transmits the data acquisition page setting to the cloud server 300 to thereby designate the display size of the tab window TW when the web browser 80 displays the data acquisition page window 83w as the tab window TW. The projection app 91 transmits the data acquisition page setting to the cloud server 300 to thereby display, in the second display size smaller than the first display size, the data acquisition page window 83w displayed as the tab window TW.

When the projection app 91 transmits the data acquisition page request and the data acquisition page setting, the cloud server 300 receives the data acquisition page request and the data acquisition page setting in step S165. The web server 310 provided to the cloud server 300 receives the data acquisition page request and the data acquisition page setting. The web server 310 acquires the data acquisition page information based on the data acquisition page address contained in the data acquisition page request.

After receiving the data acquisition page request and the data acquisition page setting, the cloud server 300 transmits the data acquisition page information to the web browser 80 in step S166. The web server 310 provided to the cloud server 300 transmits the data acquisition page information to the web browser 80.

When the cloud server 300 transmits the data acquisition page information, the web browser 80 receives the data acquisition page information in step S126.

When receiving the data acquisition page information, the web browser 80 displays the data acquisition page 83 as the tab window TW in step S127. The browser controller 31 executes acquisition page display processing of displaying the data acquisition page window 83w including the data acquisition page 83 based on the data acquisition page information. The web browser 80 displays the data acquisition page window 83w as the tab window TW in the second display size smaller than the first display size by the acquisition page display processing.

When the data acquisition page window 83w is displayed as the tab window TW on the display screen DS, the projection setting page window 81w is preferably hidden. When receiving the mirroring start instruction operation, the web browser 80 causes the browser controller 31 to execute setting window tab hiding processing of closing the projection setting page window 81w displayed as the tab window TW. The setting window tab hiding processing corresponds to an example of tab window hiding processing. The browser controller 31 performs the setting window tab hiding processing to close the projection setting page window 81w. By closing the projection setting page window 81w, multiple operations and erroneous operations on the projection setting page window 81w by the user are prevented.

After displaying the data acquisition page 83, the web browser 80 displays a selection screen 180 on the display 15 in step S128. The selection screen 180 is a screen for allowing the user to select the display screen DS to be projected by the projector 100. When displaying the selection screen 180, the web browser 80 may change the display size of the projection setting page window 81w displayed as the tab window TW.

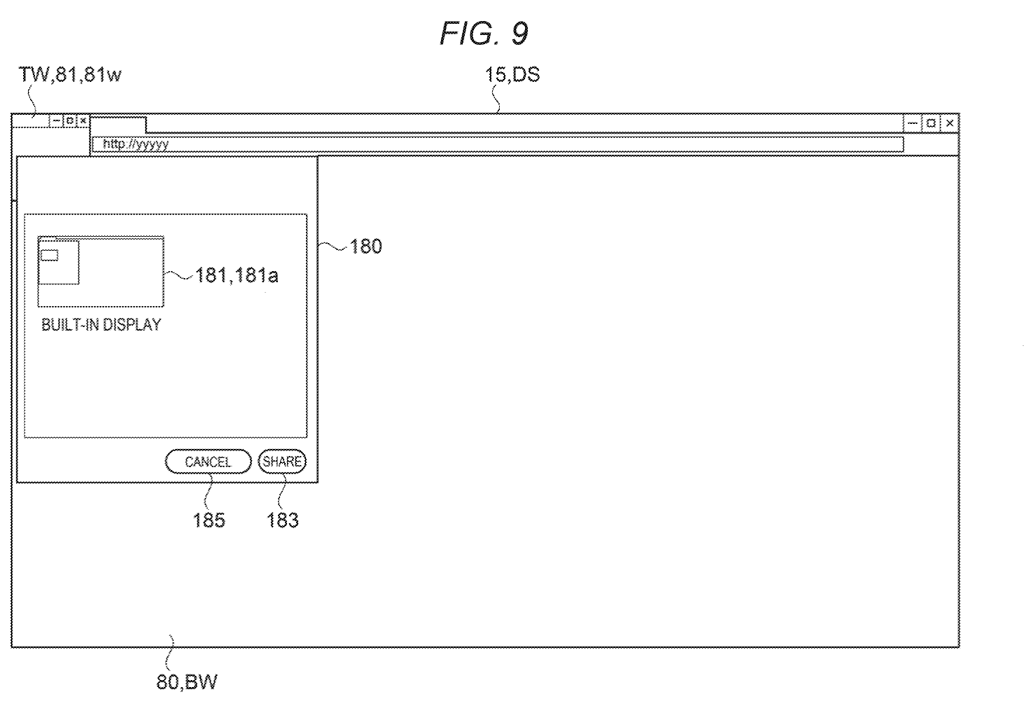

FIG. 9 illustrates an example of the display screen DS. The display screen DS is displayed on the display 15. The display screen DS shown in FIG. 9 represents the display screen DS when the web browser 80 displays the selection screen 180. The display screen DS illustrated in FIG. 9 displays the selection screen 180 and the browser window BW. The selection screen 180 is displayed on the web browser 80.

The selection screen 180 includes a selection image 181, a share icon 183, and a share cancel icon 185. The selection screen 180 displays one or more selection images 181. The selection screen 180 illustrated in FIG. 9 includes a first selection image 181a as the selection image 181. When the selection screen 180 displays a plurality of selection images 181, the plurality of selection images 181 is displayed side by side in the selection screen 180.

The selection image 181 receives an input operation by the user. The selection image 181 is a captured image of the display screen DS projected by the projector 100. The first selection image 181a is an image obtained by reducing the display screen DS shown in FIG. 9. When the user performs a predetermined selection operation on the selection image 181, the selection image 181 subjected to the selection operation is selected as the display screen DS to be projected on the projector 100.

The share icon 183 receives an input operation by the user. When the user performs a predetermined operation on the share icon 183, the web browser 80 receives the selection instruction operation. The selection image 181 subjected to the selection operation is selected as the display screen DS to be projected by the projector 100.

The share cancel icon 185 receives an input operation by the user. When the user performs a predetermined operation on the share cancel icon 185, the selection screen 180 is hidden, and mirroring is canceled. The control apparatus 10 does not transmit the shared data to the projector 100.

When the selection screen 180 is displayed on the display screen DS, the projection setting page window 81w displayed as the tab window TW is preferably displayed in a reduced size. When the selection screen 180 is displayed on the display screen DS, the web browser 80 is controlled to display the projection setting page window 81w in a reduced size. By displaying the projection setting page window 81w in a reduced size, the visibility of the selection screen 180 and the browser window BW is improved.

As illustrated in FIG. 6, after displaying the selection screen 180, the web browser 80 receives the selection instruction operation in step S129. When the user performs a predetermined operation on the share icon 183 in the selection screen 180, the web browser 80 receives the selection instruction operation. When the web browser 80 receives the selection instruction operation, the web browser 80 hides the selection screen 180.

When receiving the selection instruction operation, the web browser 80 acquires the shared data in step S130. The web browser 80 acquires generated data output from the output unit 20 as the shared data due to a function of the capture app 84 operating in the data acquisition page 83. The shared data includes the video data output from the display data output unit 21. The shared data may include the audio data output from the audio output unit 23.

When acquiring the shared data, the web browser 80 displays the data acquisition page window 83w displayed as the tab window TW in the second display size by the acquisition page display processing. By displaying the data acquisition page window 83w in the second display size, the web browser 80 can reduce an occupancy of the data acquisition page window 83w in the display screen DS. The user can visually recognize other portions without being hindered by the data acquisition page window 83w.

When the web browser 80 acquires the shared data, the web browser 80 transmits the shared data to the projector 100 in step S131. The data acquisition page 83 displayed in the data acquisition page window 83w executes shared data transmission processing of transmitting the shared data to transmit the shared data to the projector 100 based on the mirroring start instruction operation. The shared data includes the video data. The web browser 80 transmits the shared data to the projector 100 via the stream distribution path SP. The data acquisition page 83 corresponds to an example of a data transmission page. The data acquisition page window 83w corresponds to an example of a data transmission window. The control apparatus 10 executes mirroring processing of causing the projector 100 to project the display screen DS. The mirroring processing corresponds to an example of projection processing. After transmitting the shared data, the web browser 80 proceeds to a process B.

When the web browser 80 transmits the shared data to the projector 100, the projector 100 receives the shared data in step S142. The projector communicator 150 of the projector 100 receives the shared data transmitted via the stream distribution path SP. The projector controller 130 acquires the shared data via the projector communicator 150.

When receiving the shared data, the projector 100 executes mirroring in step S143. The projector 100 acquires the video data contained in the shared data. The projection controller 131 of the projector controller 130 transmits the video data to the projection unit 110. The projection controller 131 causes the projection unit 110 to project the video data. The projection unit 110 projects the projection image PG based on the video data onto the projection surface SC. When audio data is contained in the shared data, the projector 100 acquires the audio data contained in the shared data. The projection controller 131 transmits the audio data to the projector built-in speaker 120. The projector built-in speaker 120 outputs an audio based on the audio data. Based on the shared data including the video data and the audio data, the projector 100 displays the display screen DS displayed on the display 15 of the control apparatus 10, and outputs the audio based on the audio data. Based on the shared data including the video data, the projector 100 executes mirroring of projecting the display screen DS.

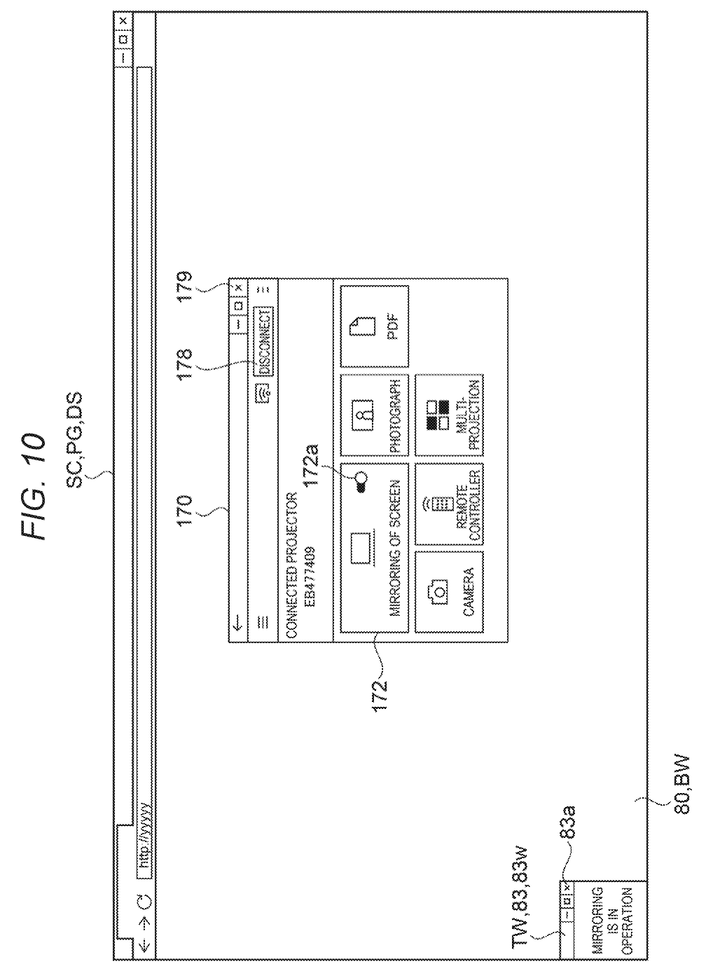

FIG. 10 shows the projection image PG projected on the projection surface SC. FIG. 10 shows the projection image PG projected on the projection surface SC when the projector 100 executes mirroring. The projection image PG is the same image as that of the display screen DS displayed on the display 15. The display screen DS having the same image as the projection image PG is displayed on the display 15.

The projection image PG includes the browser window BW and the tab window TW. The tab window TW is the data acquisition page window 83w including the data acquisition page 83. The data acquisition page window 83w displayed as the tab window TW is displayed in the second display size smaller than the first display size. Since the data acquisition page window 83w is displayed in the second display size, it becomes easy for the user to visually recognize the browser window BW. The display screen DS having the same image as the projection image PG shown in FIG. 10 is displayed on the display 15. It becomes easy for the user to visually recognize the browser window BW.

The data acquisition page window 83w has a close button 83a. When the user performs a predetermined input operation on the close button 83a, the data acquisition page window 83w is closed. When the data acquisition page window 83w is closed, the acquisition of the shared data and the transmission of the shared data to the projector 100 are stopped.

In a state in which the control apparatus 10 is transmitting the shared data, the user can perform an input operation on the UI screen 170 or the data acquisition page window 83w. The user can stop the mirroring processing by performing a predetermined input operation on the UI screen 170 or the data acquisition page window 83w.

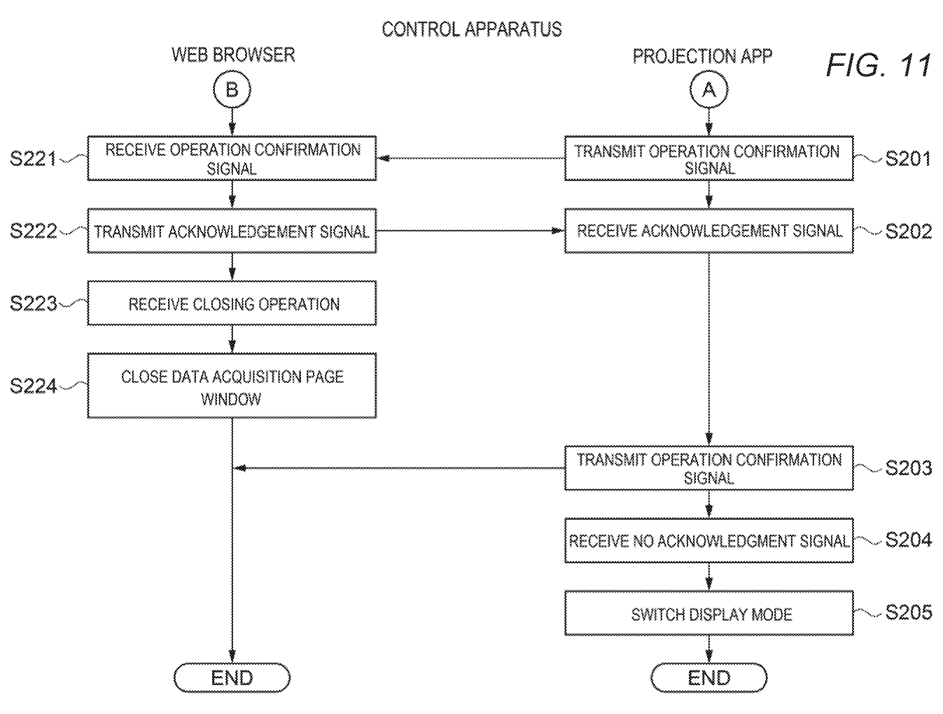

FIG. 11 shows an example of a control flow executed in the control apparatus 10. FIG. 11 shows an example of a control flow when the web browser 80 is transmitting the shared data to the projector 100. FIG. 11 shows an example of a control flow of the projection app 91 in a process A and a control flow of the web browser 80 in the process B shown in FIG. 6.

After transmitting the data acquisition page request or the data acquisition page setting, the projection app 91 transmits an operation confirmation signal to the web browser 80 in step S201. The projection app 91 transmits the operation confirmation signal to the web browser 80 at a predetermined timing. The operation confirmation signal corresponds to an example of a confirmation signal.

When the projection app 91 transmits the operation confirmation signal, the web browser 80 receives the operation confirmation signal in step S221. The data acquisition page window 83w of the web browser 80 receives the operation confirmation signal.

When receiving the operation confirmation signal, the web browser 80 transmits an acknowledgement signal to the projection app 91 in step S222. The data acquisition page window 83w transmits the acknowledgement signal to the operation confirmation signal to the projection app 91 within a predetermined time after receiving the operation confirmation signal. The acknowledgement signal corresponds to an example of a response signal.

When the web browser 80 transmits the acknowledgement signal, the projection app 91 receives the acknowledgement signal in step S202. By receiving the acknowledgement signal, the projection app 91 determines that the data acquisition page window 83w is in operation.

When the projector 100 is executing mirroring, the projection app 91 transmits the operation confirmation signal at a predetermined timing. The data acquisition page window 83w returns the acknowledgement signal to the operation confirmation signal at a predetermined timing. The projection app 91 and the data acquisition page window 83w execute polling when transmitting the shared data to the projector 100.

When executing polling, the web browser 80 may receive a closing operation in step S223 in some cases. When the user performs a predetermined input operation on the close button 83a of the data acquisition page window 83w, the closing operation of closing the data acquisition page window 83w is received. The closing operation corresponds to an example of a browser window stop operation.

When the web browser 80 receives the closing operation, the web browser 80 closes, in step S224, the data acquisition page window 83w that is displayed as tab window TW. When the data acquisition page window 83w is closed, the function of the capture app 84 stops. The acquisition of the shared data and the transmission of the shared data are stopped. The shared data is not transmitted to the projector 100, and the mirroring processing is stopped.

After the web browser 80 closes the data acquisition page window 83w, the projection app 91 transmits the operation confirmation signal in step S203. In the control flow illustrated in FIG. 11, the projection app 91 cannot identify that the user has performed the closing operation on the data acquisition page window 83w. The projection app 91 transmits the operation confirmation signal to the web browser 80 at a predetermined timing independently of the state of the data acquisition page window 83w.

After transmitting the operation confirmation signal, the projection app 91 does not receive the acknowledgement signal within a predetermined time in step S204. The data acquisition page window 83w transmits the acknowledgement signal to the operation confirmation signal during the operation to the projection app 91 within a predetermined time. When the data acquisition page window 83w is closed, the acknowledgement signal is not transmitted to the projection app 91. When the projection app 91 fails to receive the acknowledgement signal within a predetermined time, the projection app 91 determines that the data acquisition page window 83w is closed. The projection app 91 determines that the mirroring processing is stopped.

When the projection app 91 fails to receive the acknowledgement signal, the projection app 91 switches the display mode of the UI screen 170 in step S205. When the app controller 33 determines that the mirroring processing stops, the app controller 33 performs display mode change processing of changing the display mode.

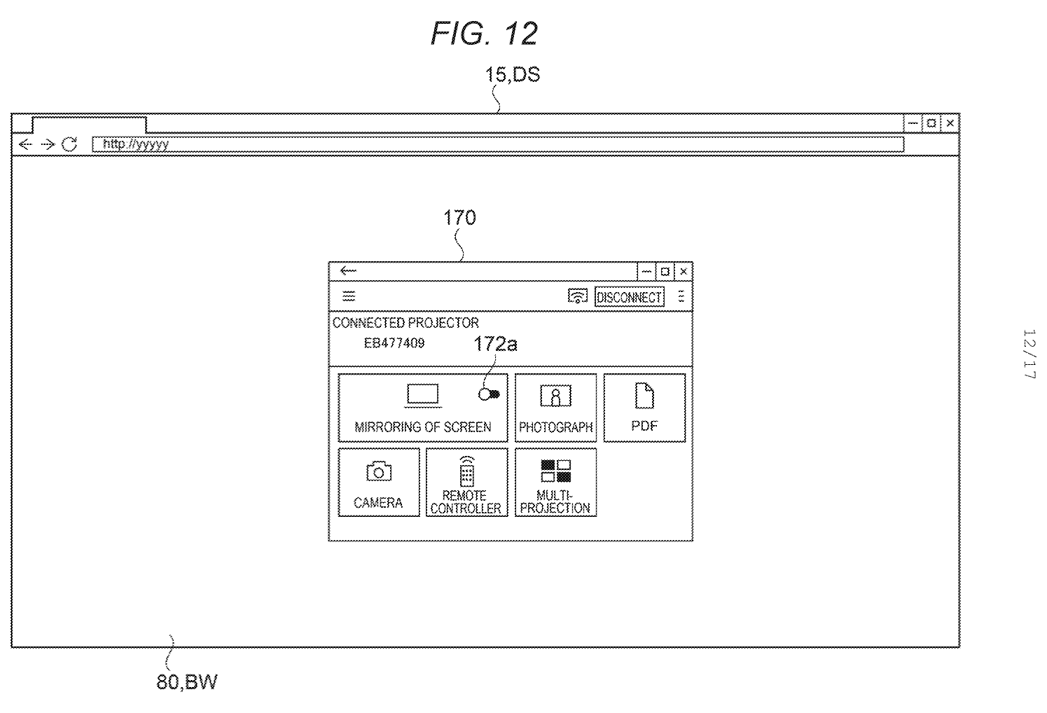

FIG. 12 illustrates an example of the display screen DS. The display screen DS is displayed on the display 15. The display screen DS shown in FIG. 12 represents the display screen DS when the data acquisition page window 83w that is displayed as the tab window TW is closed. The display screen DS illustrated in FIG. 12 displays the UI screen 170 and the browser window BW. The UI screen 170 is displayed on the web browser 80.

When the data acquisition page window 83w is closed, the app controller 33 slides the switch icon 172a to the left to make a change to a stop indication representing that the mirroring processing is not in operation. The stop indication corresponds to an example of stop information. The display mode change processing corresponds to an example of display change processing. The projection app 91 makes a change to the stop indication in response to the closing operation on the data acquisition page window 83w by the user. Since the state of the data acquisition page window 83w and the display mode of the projection app 91 are linked with each other, the user can surely recognize that the mirroring processing is stopped.

The control flow of the control apparatus 10 includes activating the projection app 91 for controlling the projector 100 and displaying the UI screen 170 for operating the projection app 91, establishing communicative connection to the projector 100, displaying the data acquisition page window 83w including the data acquisition page 83 related to projection on the web browser 80 based on the data acquisition page request from the projection app 91, executing mirroring processing of transmitting video data for displaying the display screen DS to the projector 100 via the web browser 80 to cause the projector 100 to project the display screen DS, displaying the execution indication indicating that the mirroring processing is in operation on the UI screen 170, receiving the closing operation of closing the data acquisition page window 83w, stopping the mirroring processing and closing the data acquisition page window 83w based on the closing operation, and executing the display mode change processing of changing the execution indication to the stop indication representing that the mirroring processing is not in operation.

The state of the data acquisition page window 83w and the display mode of the projection app 91 match each other in the display representing that the mirroring processing is not in operation. The user can visually recognize with certainty that the control apparatus 10 is not executing the mirroring processing.

The control flow of the control apparatus 10 preferably includes causing the projection app 91 to transmit the operation confirmation signal to the data acquisition page window 83w at a predetermined timing when the mirroring processing is in operation, and executing the display mode change processing when the projection app 91 does not receive the acknowledgement signal to the operation confirmation signal from the data acquisition page window 83w.

By performing the processing in which the projection app 91 transmits the operation confirmation signal and the data acquisition page window 83w returns the acknowledgement signal to the operation confirmation signal, the projection app 91 can determine that the data acquisition page window 83w is closed.

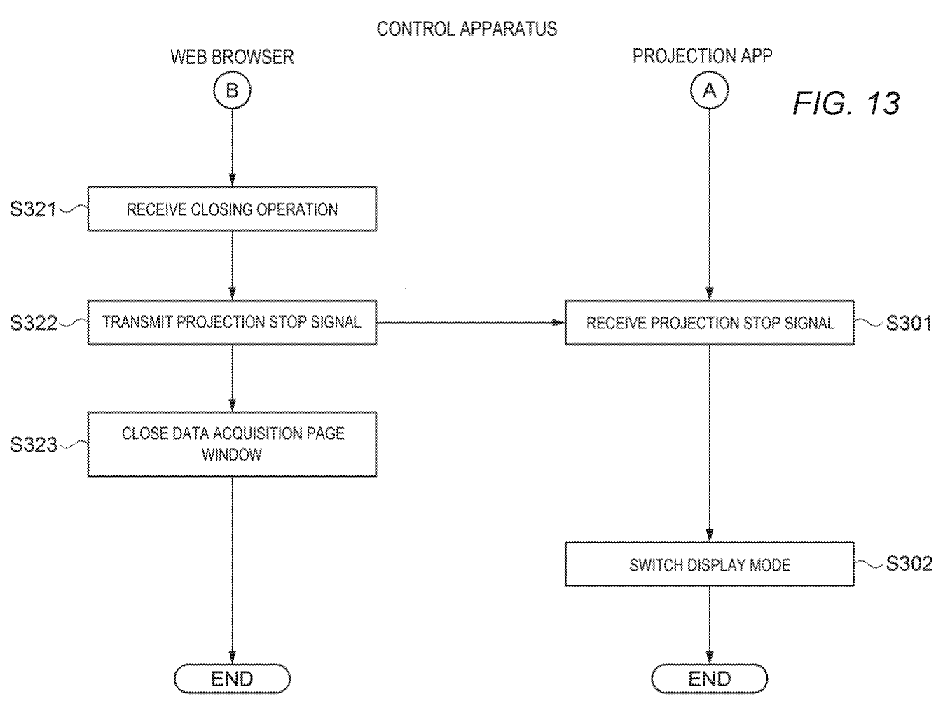

FIG. 13 shows an example of a control flow executed in the control apparatus 10. FIG. 13 shows an example of a control flow when the web browser 80 is transmitting the shared data to the projector 100. FIG. 13 shows an example of a control flow of the projection app 91 in the process A and a control flow of the web browser 80 in the process B shown in FIG. 6. In the control flow illustrated in FIG. 13, the projection app 91 does not transmit the operation confirmation signal to the web browser 80. FIG. 13 shows a control flow different from that in FIG. 11.

When transmitting the shared data to the projector 100, the web browser 80 may receive the closing operation in step S321 in some cases. When the user performs a predetermined input operation on the close button 83a of the data acquisition page window 83w, the closing operation of closing the data acquisition page window 83w is received.

When receiving the closing operation, the web browser 80 transmits a projection stop signal to the projection app 91 in step S322. When the capture app 84 operating on the data acquisition page 83 has a function of transmitting the projection stop signal, the capture app 84 determines that the closing operation has been received. When it is determined that the closing operation has been received, the capture app 84 transmits the projection stop signal to the projection app 91. The projection stop signal is a signal representing that the data acquisition page window 83w is closed and the mirroring processing is terminating. The projection stop signal corresponds to an example of a stop signal.

When the web browser 80 transmits the projection stop signal, the projection app 91 receives the projection stop signal in step S301. When the projection app 91 receives the projection stop signal, the projection app 91 determines that the data acquisition page window 83w is closed and the mirroring processing is terminating.

When the web browser 80 receives the closing operation, the web browser 80 closes, in step S323, the data acquisition page window 83w that is displayed as the tab window TW. When the data acquisition page window 83w is closed, the function of the capture app 84 stops. The acquisition of the shared data and the transmission of the shared data are stopped. The shared data is not transmitted to the projector 100, and the mirroring processing is stopped.

When the projection app 91 receives the projection stop signal, the projection app 91 switches the display mode of the UI screen 170 in step S302. When the app controller 33 determines that the mirroring processing stops, the app controller 33 performs display mode change processing of changing the display mode. The app controller 33 slides the switch icon 172a to the left to make a change to the stop indication representing that the mirroring processing is not in operation. The projection app 91 makes a change to the stop indication in response to the closing operation on the data acquisition page window 83w by the user. Since the state of the data acquisition page window 83w and the display mode of the projection app 91 are linked with each other, the user can surely recognize that the mirroring processing is stopped.

In the control flow of the control apparatus 10, when the closing operation is received, the capture app 84 that operates in the data acquisition page window 83w preferably includes transmitting, to the projection app 91, the projection stop signal representing that the mirroring processing is terminating, and causing the projection app 91 to execute the display mode change processing.

By the capture app 84 transmitting the projection stop signal to the projection app 91, the projection app 91 can determine that the mirroring processing has terminated.

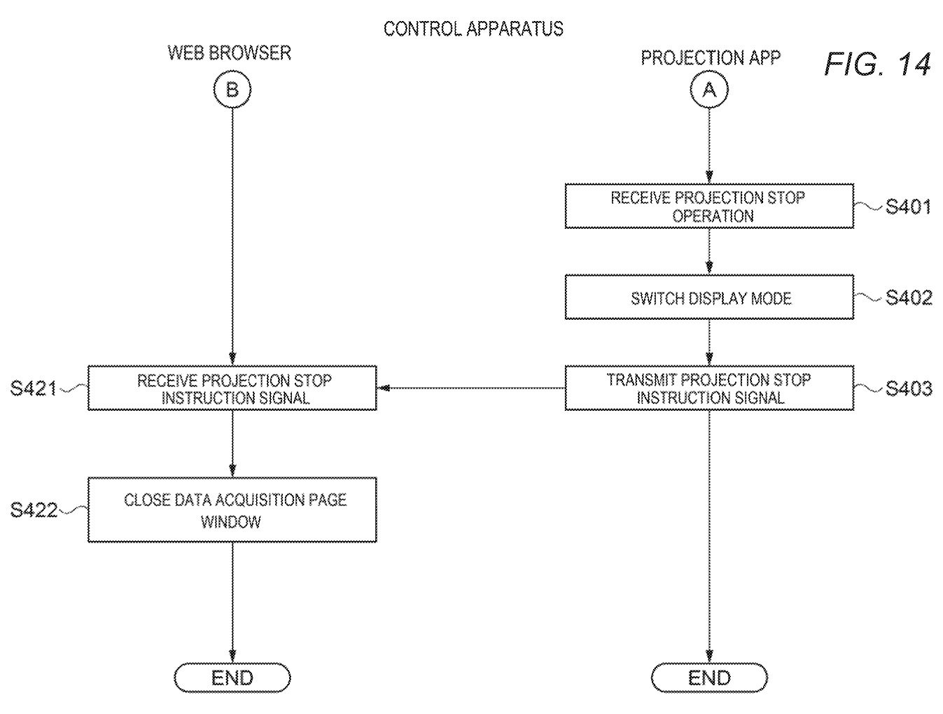

FIG. 14 shows an example of a control flow executed in the control apparatus 10. FIG. 14 shows an example of a control flow when the web browser 80 is transmitting the shared data to the projector 100. FIG. 14 shows an example of a control flow of the projection app 91 in the process A and a control flow of the web browser 80 in the process B shown in FIG. 6.

FIG. 14 illustrates a control flow when the user performs an input operation on the switch icon 172a of the UI screen 170 during the transmission of the shared data by the web browser 80. FIG. 14 illustrates a control flow of stopping the mirroring processing in response to the input operation by the user.

In step S401, the projection app 91 receives a projection stop operation. The user performs a predetermined projection stop operation on the mirroring reception icon 172 or the switch icon 172a on the UI screen 170. The projection stop operation is an input operation for stopping the mirroring processing. The projection stop operation corresponds to an example of a stop operation. As an example, the user performs a display change operation of sliding the switch icon 172a illustrated in FIG. 10 from right to left. The display change operation corresponds to an example of a change operation. The user may perform, as the projection stop operation, a click operation of clicking on the mirroring reception icon 172 including the execution indication. When the user performs the projection stop operation, the projection app 91 receives the projection stop operation.

When the projection app 91 receives the projection stop operation, the projection app 91 switches the display mode in step S402. The projection app 91 switches the switch icon 172a from the execution indication to the stop indication in response to the projection stop operation. By the display of the switch icon 172a being switched, the user can confirm that the projection stop operation has been received.

When the projection app 91 receives the projection stop operation, the projection app 91 transmits a projection stop instruction signal to the web browser 80 in step S403. The projection app 91 generates the projection stop instruction signal. The projection stop instruction signal is a signal for causing the web browser 80 to close the data acquisition page window 83w that is displayed as the tab window TW and to stop the transmission of the shared data. The projection stop instruction signal corresponds to an example of a browser stop signal. The projection app 91 transmits the projection stop instruction signal thus generated to the web browser 80.

When the projection app 91 transmits the projection stop instruction signal, the web browser 80 receives the projection stop instruction signal in step S421. The data acquisition page window 83w of the web browser 80 receives the projection stop instruction signal.

When receiving the projection stop instruction signal, the web browser 80 closes the data acquisition page window 83w in step S422. The web browser 80 closes the data acquisition page window 83w based on the projection stop instruction signal. When the data acquisition page window 83w is closed, the transmission of the shared data to the projector 100 is stopped, and the mirroring processing is stopped.

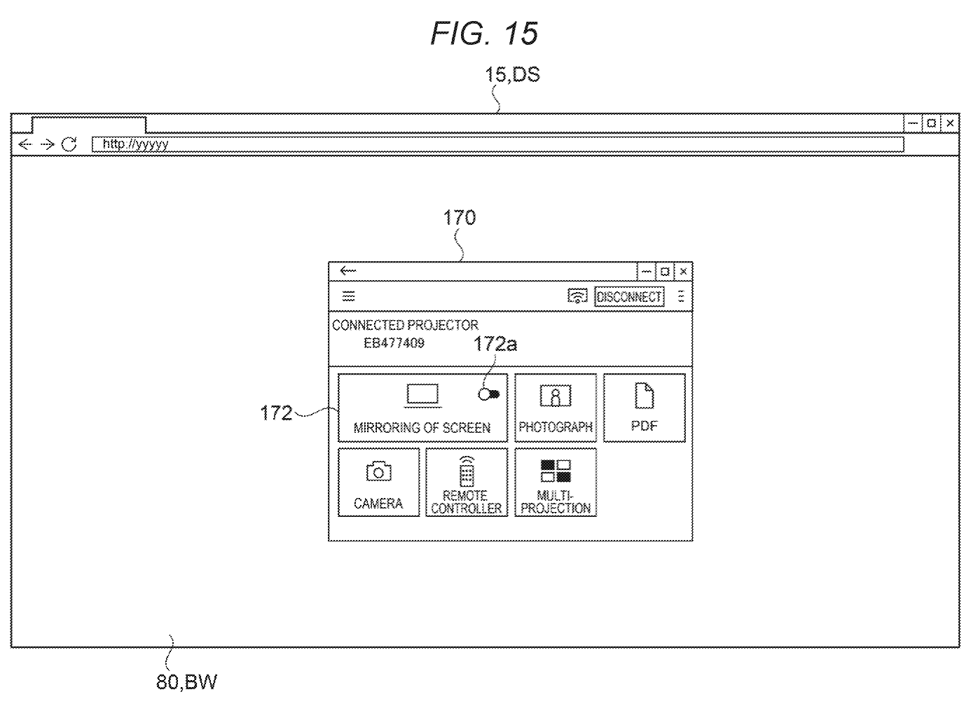

FIG. 15 illustrates an example of the display screen DS. The display screen DS is displayed on the display 15. The display screen DS shown in FIG. 15 represents the display screen DS when the user performs the projection stop operation on the UI screen 170.

When the user performs the projection stop operation on the UI screen 170, the switch icon 172a slides to the left to be switched to the stop indication as shown in FIG. 15. Further, the data acquisition page window 83w displayed as the tab window TW shown in FIG. 10 is closed to be hidden. The user can confirm that the mirroring processing is stopped by visually recognizing the display screen DS. When the data acquisition page window 83w displayed as the tab window TW is closed, the web browser 80 maintains the display of the browser window BW that does not contribute to the transmission of the shared data.

The control flow of the control apparatus 10 includes activating the projection app 91 for controlling the projector 100 and displaying the UI screen 170 for operating the projection app 91, establishing communicative connection to the projector 100, displaying the data acquisition page window 83w including the data acquisition page 83 related to projection on the web browser 80 based on the data acquisition page request from the projection app 91, executing mirroring processing of transmitting video data for displaying the display screen DS to the projector 100 via the web browser 80 to cause the projector 100 to project the display screen DS, displaying the execution indication indicating that the mirroring processing is in operation on the UI screen 170, receiving the projection stop operation of stopping the mirroring processing on the UI screen 170, and stopping the mirroring processing and closing the data acquisition page window 83w based on the projection stop operation.

By closing the data acquisition page window 83w based on the projection stop operation, the projection app 91 can make it easy for the user to determine that the mirroring processing is stopped.

The projection stop operation is a display change operation of changing the execution indication to the stop indication indicating that the mirroring processing is not in operation. The control flow of the control apparatus 10 preferably includes causing the projection app 91 to generate the projection stop instruction signal for closing the data acquisition page window 83w based on the display change operation, causing the projection app 91 to transmit the projection stop instruction signal to the web browser 80, and causing the web browser 80 to terminate the mirroring processing based on the projection stop instruction signal.

By the projection app 91 transmitting the projection stop instruction signal to the web browser 80, it is possible to cause the web browser 80 to close the data acquisition page window 83w.

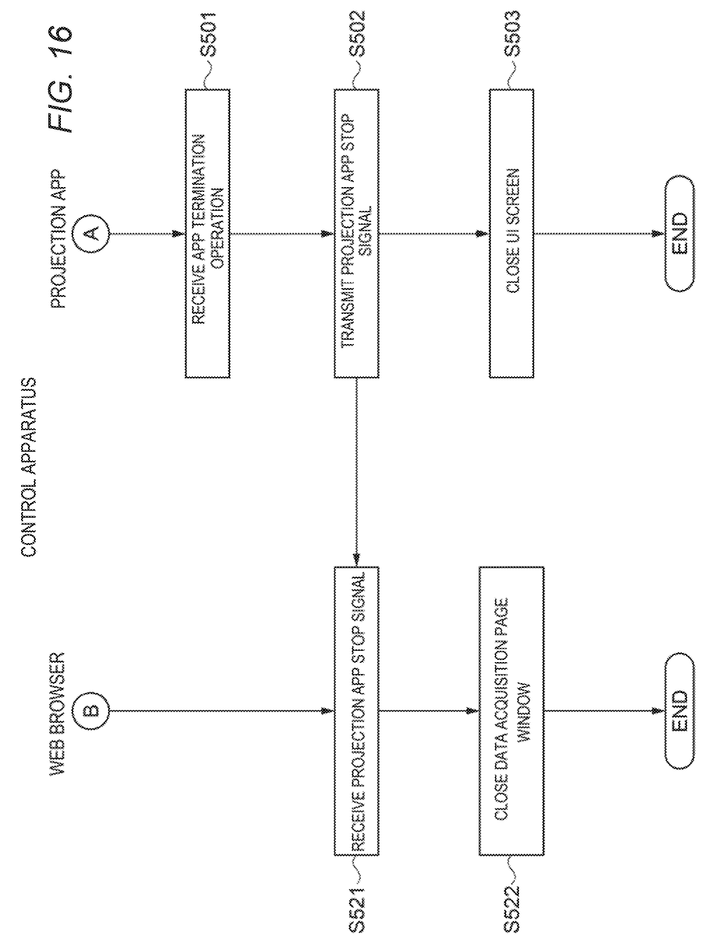

FIG. 16 shows an example of a control flow executed in the control apparatus 10. FIG. 16 shows an example of a control flow when the web browser 80 is transmitting the shared data to the projector 100. FIG. 16 shows an example of a control flow of the projection app 91 in the process A and a control flow of the web browser 80 in the process B shown in FIG. 6.

FIG. 16 illustrates a control flow when the user performs an input operation on the termination reception icon 179 of the UI screen 170 during the transmission of the shared data by the web browser 80. FIG. 16 illustrates a control flow of stopping the mirroring processing in response to the input operation by the user.

In step S501, the projection app 91 receives the app termination operation. The user performs a predetermined projection stop operation on the disconnection reception icon 178 or the termination reception icon 179 on the UI screen 170. As an example, the user performs the app termination operation on the termination reception icon 179 illustrated in FIG. 10. The termination reception icon 179 corresponds to an example of an application termination icon. The app termination operation corresponds to an example of a termination instruction operation. When the user performs the app termination operation, the projection app 91 receives the app termination operation.

When the projection app 91 receives the app termination operation, the projection app 91 transmits a projection app stop signal to the web browser 80 in step S502. The projection app 91 generates the projection app stop signal. The projection app stop signal is a signal representing that the projection app 91 has terminated. The projection app stop signal corresponds to an example of an application stop signal. The projection app 91 transmits the projection app stop signal thus generated to the web browser 80.

When receiving the app termination operation, the projection app 91 closes the UI screen 170 in step S503. The projection app 91 closes the UI screen 170 and hides the UI screen 170 in response to the app termination operation. By the UI screen 170 being closed, the user can confirm that the app termination operation has been received.

When the projection app 91 transmits the projection app stop signal, the web browser 80 receives the projection app stop signal in step S521. The data acquisition page window 83w of the web browser 80 receives the projection app stop signal.

When receiving the projection app stop signal, the web browser 80 closes the data acquisition page window 83w in step S522. The web browser 80 closes the data acquisition page window 83w based on the projection app stop signal. When the data acquisition page window 83w is closed, the transmission of the shared data to the projector 100 is stopped, and the mirroring processing is stopped.

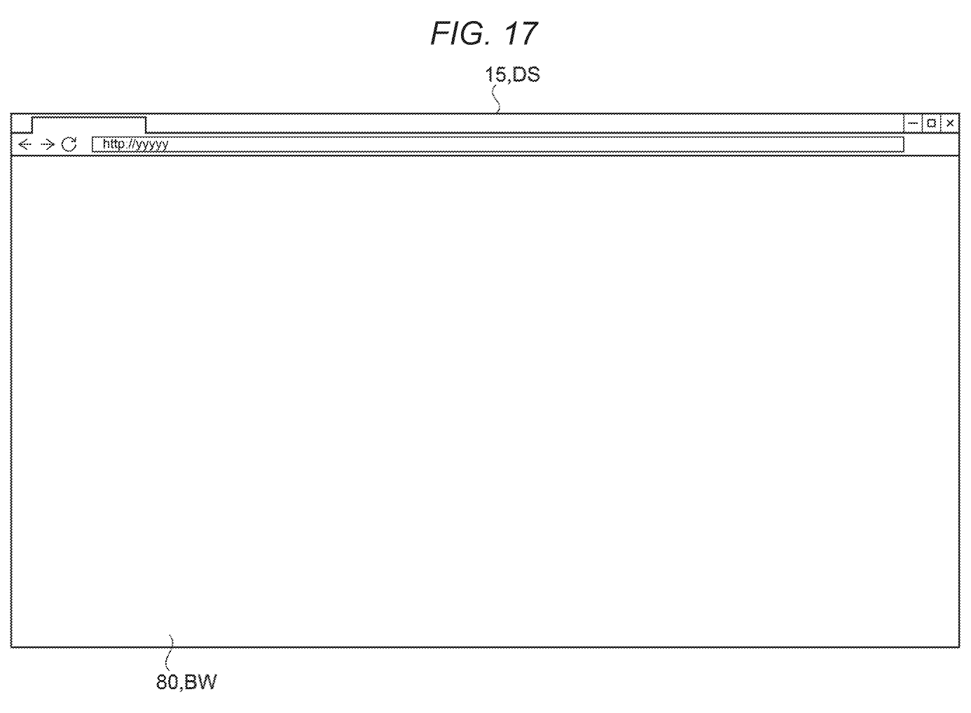

FIG. 17 illustrates an example of the display screen DS. The display screen DS is displayed on the display 15. The display screen DS shown in FIG. 17 represents the display screen DS when the user performs the app termination operation on the UI screen 170.

When the user performs the app termination operation on the UI screen 170, the UI screen 170 is closed to be hidden as illustrated in FIG. 17. Further, the data acquisition page window 83w displayed as the tab window TW shown in FIG. 10 is closed to be hidden. The user can confirm that the mirroring processing is stopped by visually recognizing the display screen DS. When the data acquisition page window 83w displayed as the tab window TW is closed, the web browser 80 maintains the display of the browser window BW that does not contribute to the transmission of the shared data.

The projection stop operation is the app termination operation on the termination reception icon 179 provided to the UI screen 170. The control flow of the control apparatus 10 preferably includes hiding the UI screen 170 based on the app termination operation, causing the projection app 91 to generate the projection app stop signal representing that the projection app 91 has terminated based on the app termination operation, causing the projection app 91 to transmit the projection app stop signal to the web browser 80, and causing the web browser 80 to close the data acquisition page window 83w based on the projection app stop signal.

By the projection app 91 transmitting the projection app stop signal to the web browser 80, it is possible to cause the web browser 80 to close the data acquisition page window 83w.

A summary of the present disclosure will be appended below.

### Appendix 1

A method of processing information in an information processing apparatus including starting an application program configured to control a projection apparatus and displaying an application program window for operating the application program, linking to the projection apparatus through a network for data transfer, displaying, on a web browser, a data transmission window including a data transmission page related to projection based on an operation instruction from the application program, executing projection processing of transmitting display data for displaying a display screen to the projection apparatus via the web browser to instruct the projection apparatus to project the display screen, displaying execution information representing that the projection processing is in operation in the application program window, receiving a browser window stop operation of closing the data transmission window, stopping the projection processing and closing the data transmission window based on the browser window stop operation, and executing display change processing of changing the execution information to stop information representing that the projection processing is not in operation.

The state of the data transmission window and the display mode of the application program window match each other in the display representing that the mirroring processing is not in operation. The user can visually recognize with certainty that the projection apparatus is not executing the projection processing.

### Appendix 2

The method of processing information in the information processing apparatus according to Appendix 1 further includes instructing the application program to transmit a confirmation signal to the data transmission window at a predetermined timing when the projection processing is in operation, and executing the display change processing when the application program does not receive a response signal to the confirmation signal from the data transmission window.

By performing processing in which the application program transmits the confirmation signal and the data transmission window returns the response signal to the confirmation signal, the application program can determine that the data transmission window is closed.

### Appendix 3

In the method of processing information in the information processing apparatus according to Appendix 1, when the browser window stop operation is received, a web application operating in the data transmission window includes transmitting, to the application program, a stop signal representing that the projection processing terminates, and instructing the application program to execute the display change processing.

By the web application transmitting the stop signal to the application program, the application program can determine that the projection processing has terminated.

### Appendix 4

A method of processing information in an information processing apparatus includes starting an application program configured to control a projection apparatus and displaying an application program window for operating the application program, linking to the projection apparatus through a network for data transfer, displaying, on a web browser, a data transmission window including a data transmission page related to projection based on an operation instruction from the application program, executing projection processing of transmitting display data for displaying a display screen to the projection apparatus via the web browser to instruct the projection apparatus to project the display screen, displaying execution information representing that the projection processing is in operation in the application program window, receiving a stop operation of stopping the projection processing in the application program window, and stopping the projection processing and closing the data transmission window based on the stop operation.

By closing the data transmission window based on the stop operation, the application program can make it easy for the user to determine that the projection processing is stopped.

### Appendix 5

The method of processing information in the information processing apparatus according to Appendix 4, wherein the stop operation is a change operation of changing the execution information to stop information representing that the projection processing is not in operation, further includes instructing the application program to generate a browser stop signal of closing the data transmission window based on the change operation, instructing the application program to transmit the browser stop signal to the web browser, and instructing the web browser to terminate the projection processing based on the browser stop signal.

By the application program transmitting the browser stop signal to the web browser, it is possible to cause the web browser to close the data transmission window.

### Appendix 6

The method of processing information in the information processing apparatus according to Appendix 4, wherein the stop operation is a termination instruction operation on an application termination icon provided to the application program window, further includes hiding the application program window based on the termination instruction operation, instructing the application program to generate an application stop signal representing that the application program terminates based on the termination instruction operation, instructing the application program to transmit the application stop signal to the web browser, and instructing the web browser to close the data transmission window based on the application stop signal.

By the application program transmitting the application stop signal to the web browser, it is possible to cause the web browser to close the data transmission window.

What is claimed is:

1. A method of processing information in an information processing apparatus comprising:
starting an application program configured to control a projection apparatus and displaying an application program window for operating the application program;
linking to the projection apparatus through a network for data transfer;
displaying, on a web browser, a data transmission window including a data transmission page related to projection based on an operation instruction from the application program;
executing projection processing of transmitting display data for displaying a display screen to the projection apparatus via the web browser to instruct the projection apparatus to project the display screen;
displaying execution information representing that the projection processing is in operation in the application program window;
receiving a browser window stop operation of closing the data transmission window;
stopping the projection processing and closing the data transmission window based on the browser window stop operation; and
executing display change processing of changing the execution information to stop information representing that the projection processing is not in operation.

2. The method of processing information in the information processing apparatus according to claim 1, further comprising:
instructing the application program to transmit a confirmation signal to the data transmission window at a predetermined timing when the projection processing is in operation; and
executing the display change processing when the application program does not receive a response signal to the confirmation signal from the data transmission window.

3. The method of processing information in the information processing apparatus according to claim 1, wherein
when the browser window stop operation is received, a web application operating in the data transmission window includes:
transmitting, to the application program, a stop signal representing that the projection processing terminates; and
instructing the application program to execute the display change processing.

4. A method of processing information in an information processing apparatus comprising:
starting an application program configured to control a projection apparatus and displaying an application program window for operating the application program;
linking to the projection apparatus through a network for data transfer;
displaying, on a web browser, a data transmission window including a data transmission page related to projection based on an operation instruction from the application program;
executing projection processing of transmitting display data for displaying a display screen to the projection apparatus via the web browser to instruct the projection apparatus to project the display screen;
displaying execution information representing that the projection processing is in operation in the application program window;
receiving a stop operation of stopping the projection processing in the application program window; and
stopping the projection processing and closing the data transmission window based on the stop operation.

5. The method of processing information in the information processing apparatus according to claim 4, wherein
the stop operation is a change operation of changing the execution information to stop information representing that the projection processing is not in operation, further comprising:
instructing the application program to generate a browser stop signal of closing the data transmission window based on the change operation;
instructing the application program to transmit the browser stop signal to the web browser; and
instructing the web browser to terminate the projection processing based on the browser stop signal.

6. The method of processing information in the information processing apparatus according to claim 4, wherein
the stop operation is a termination instruction operation on an application termination icon provided to the application program window, further comprising:
hiding the application program window based on the termination instruction operation;
instructing the application program to generate an application stop signal representing that the application program terminates based on the termination instruction operation;
instructing the application program to transmit the application stop signal to the web browser; and
instructing the web browser to close the data transmission window based on the application stop signal.
